(19) United States
(12) Patent Application Publication
(10) Pub. No.: US 2025/0140125 A1
(43) Pub. Date: May 1, 2025

(54) Generating, interpreting and adapting a 3D learning environment using ANNs

(71) Applicant: Labster ApS, Kobenhavn V (DK)

(72) Inventors: Michael Bodekaer Jensen, Schindellegi (CH); Mads Tvillinggaard Bonde, Copenhagen (DK); Matthias Roland Heim, Müllheim (CH)

(21) Appl. No.: 18/932,157

(22) Filed: Oct. 30, 2024

Related U.S. Application Data
(60) Provisional application No. 63/594,854, filed on Oct. 31, 2023.

(51) Int. Cl. G09B 5/08

(52) U.S. Cl. CPC G09B 5/08

(57) ABSTRACT

A simulated environment is generated and adapted through interaction with a user. Prior performance metrics indicating behavior of a student in performing a prior learning task are obtained. A student profile is updated based on the prior performance metrics. Lesson parameters indicating content to be included in an interactive lesson are obtained. Rules for the interactive lesson are then generated based on the student profile and the lesson parameters. The rules are applied to a classifier trained via a reference data set representing prior performance of a student population. Via the classifier, instructions for generating a simulated environment encompassing the interactive lesson are generated. A representation of the simulated environment is then generated based on the instructions.

### RELATED APPLICATION

This application claims the benefit of U.S. Provisional Application No. 63/594,854, filed on Oct. 31, 2023. The entire teachings of the above application are incorporated herein by reference.

### BACKGROUND

Advancements in educational technology have significantly transformed the learning landscape, introducing new methods to engage learners and personalize education. Technologies such as adaptive learning systems, augmented reality (AR), virtual reality (VR), and three-dimensional (3D) learning environments offer immersive experiences that simulate real-world scenarios, making complex concepts more accessible and engaging across various educational levels.

However, integrating sophisticated artificial intelligence, especially Artificial Neural Networks (ANNs), with 3D learning environments presents several challenges. Traditional adaptive learning systems often rely on transmitting high-resolution visual data to represent 3D environments, which demands substantial internet bandwidth and computational processing resources. This reliance leads to increased latency, higher costs, and limited accessibility, particularly in regions with constrained internet connectivity or on devices with lower computational capabilities.

### SUMMARY

Example embodiments include a method of generating a simulated environment. Prior performance metrics indicating behavior of a student in performing a prior learning task are obtained. A student profile is updated based on the prior performance metrics. Lesson parameters indicating content to be included in an interactive lesson are obtained. Rules for the interactive lesson are then generated based on the student profile and the lesson parameters. The rules are applied to a classifier trained via a reference data set representing prior performance of a student population. Via the classifier, instructions for generating a simulated environment encompassing the interactive lesson are generated. A representation of the simulated environment is then generated based on the instructions.

The prior performance metrics may include at least one of success rate, time taken to complete the prior learning task, and number of attempts at completing the prior learning task. Updating the student profile may include determining, based on the prior performance metrics, the student's aptitude for at least one of a plurality of distinct learning abilities. The lesson parameters may include representations of at least one of 1) required subject matter, 2) restricted subject matter, 3) proportion of passive lesson time versus interactive lesson time, and 4) proportion of collaborative time versus non-collaborative time. The lesson parameters may be based on a selection by an educator. The rules may represent at least a subset of the lesson parameters and the student profile. The instructions may include a table storing a set of parameters for generating the simulated environment encompassing the interactive lesson.

The classifier may be an artificial neural network (ANN) operating a large language model (LLM). A student device may be configured to operate the simulated environment, the student device being at least one of a virtual reality (VR) headset, and augmented reality (AR) headset, and a smartphone.

The method may further comprise 1) obtaining performance metrics indicating behavior of the student associated with the simulated environment, and 2) generating subsequent rules for a subsequent interactive lesson based on the performance metrics. The subsequent rules may be applied to the classifier, and subsequent instructions may be generated, via the classifier, for generating a subsequent simulated environment encompassing the subsequent interactive lesson. A representation of the subsequent simulated environment may then be generated based on the subsequent instructions.

The simulated environment may be a simulated 3D environment encompassing interactive simulated objects within the 3D environment. The method of claim 1, wherein the reference data set is a first reference data set, and wherein the classifier is trained via a second reference data set including parameters of reference simulated environments encompassing reference interactive lessons.

The rules for the interactive lesson may include a pedagogy mode defining at least one of 1) a sequence of content presentation and 2) a mode of content presentation. An emotional state of the student may be measured during performance of the prior learning task based on the prior performance metrics, and rules for the interactive lesson may be generated based on the emotional state. The rules for the interactive lesson may be generated to include a text-based representation of a simulated 3D environment, the rules for the interactive lesson including the text-based representation.

Further embodiments include a computer-implemented method adapting a three-dimensional (3D) virtual learning environment. A current state of the 3D virtual learning environment may be captured, the state including data representing objects within the environment and the learner's interactions with the objects. From the captured state, structured textual data representing the objects and the interactions within the 3D virtual environment may be generated. The structured textual data may be processed, by an artificial neural network (ANN), to generate adaptation instructions, wherein the adaptation instructions include at least one of function calls and commands for modifying the 3D virtual environment. The 3D virtual environment may then be modified based on the adaptation instructions.

Capturing the current state may include detecting positions, properties, and relationships of interactive objects within the 3D virtual environment. The structured textual data may include descriptions of the learner's interactions, including movements, object manipulations, and inputs. The structured textual data may be processed, via the ANN, in conjunction with a learner profile that includes the learner's preferences, performance metrics, and learning objectives. The learner profile may be updated based on the learner's interactions and performance within the 3D virtual environment.

The adaptation instructions generated by the ANN may executed, via an adaptive agent, to modify the 3D virtual environment. At least one of real-time feedback, guidance, and instructional content may be provided to the learner, via the adaptive agent, within the 3D virtual environment.

The process of converting the captured state into structured textual data may reduce data transmission requirements compared to transmitting visual data, thereby optimizing bandwidth usage. The real-time modification of the 3D virtual environment may include dynamically creating, altering, or removing virtual objects or scenarios based on the adaptation instructions.

Adaptation instructions that adjust at least one of the difficulty level, presentation style, and pacing of the learning content based on the learner's interactions may be generated via the ANN. The structured textual data may be transmitted to a remote server for processing by the ANN, wherein the ANN is hosted on the remote server. The 3D virtual learning environment may be accessed via a device selected from one or more of a desktop computer, a mobile device, a virtual reality (VR) headset, and an augmented reality (AR) device. The structured textual data may include dynamic attributes of objects, including state changes, temperature, or other properties relevant to the learning experience.

The adaptation instructions may be generated based on the structured textual data and lesson parameters provided by an educator. The lesson parameters may include educational objectives, content restrictions, or preferred pedagogical strategies. The adaptive learning experience may include personalized narratives or storylines generated by the ANN to enhance learner engagement. An emotional state of the learner may be detected, via the ANN, based on at least one of the structured textual data and emotion-tracking data. The adaptation instructions may indicate modifications to the learning content or environment to maintain or enhance the learner's engagement based on the detected emotional state. The structured textual data may be formatted in at least one of a plaintext, JSON, or XML format. The adaptation instructions generated by the ANN may include instructions for generating or selecting pre-designed pedagogical frameworks or learning activity templates.

### BRIEF DESCRIPTION OF THE DRAWINGS

The foregoing will be apparent from the following more particular description of example embodiments, as illustrated in the accompanying drawings in which like reference characters refer to the same parts throughout the different views. The drawings are not necessarily to scale, emphasis instead being placed upon illustrating embodiments.

FIG. 1 is a diagram of an adaptive learning system in one embodiment.

FIG. 2 is a diagram depicting features of an adaptive learning system in one embodiment.

FIG. 3 is a diagram illustrating applications of an adaptive learning system in one embodiment.

FIG. 4 is a diagram of an adaptation process in one embodiment.

FIG. 5 depicts an example learning map in one embodiment.

FIG. 6 illustrates a user interface featuring an adaptive agent in one embodiment.

FIG. 7 illustrates a user interface featuring generation and manipulation of objects in one embodiment.

FIG. 8 is a block diagram illustrating stages of a learning experience in one embodiment.

FIG. 9 is a diagram illustrating cross-platform compatibility in one embodiment.

FIG. 10 is a diagram illustrating limitations of certain learning systems.

FIG. 11 illustrates a user interface featuring a laboratory environment in one embodiment.

FIG. 12 illustrates operation of an environment state processor in one embodiment.

FIG. 13 illustrates a user interface featuring interaction with an instructor in one embodiment.

FIG. 14 illustrates a user interface featuring a course in one embodiment.

FIG. 15 illustrates a scenario of a user interaction with an adaptive learning system in one embodiment.

### DETAILED DESCRIPTION

A description of example embodiments follows.

Traditional adaptive learning systems often rely on transmitting high-resolution visual data to represent 3D environments, which demands substantial internet bandwidth and computational processing resources. This reliance leads to increased latency, higher costs, and limited accessibility, particularly in regions with constrained internet connectivity or on devices with lower computational capabilities.

Moreover, existing systems typically require extensive pre-designed educational content and lack the flexibility to adapt in real time to individual learners' needs. The high costs and effort associated with creating and delivering such content hinder scalability and personalization. Additionally, these systems often struggle to provide real-time feedback and adaptability, which are crucial for maintaining learner engagement and optimizing educational outcomes.

A critical limitation lies in the fact that Large Language Models (LLMs) are inherently designed for text-based data processing, making it challenging to integrate them effectively with visual-heavy 3D environments. This disconnect prevents the full exploitation of LLMs' potential in enhancing personalization and adaptability within immersive learning experiences.

There is a compelling need for an innovative solution that bridges the gap between advanced AI capabilities and immersive 3D learning environments. Such a solution should address the challenges of high bandwidth consumption, latency, and computational costs while enabling real-time generation, adaptation, and personalization. Leveraging the strengths of LLMs in understanding and generating textual data could allow for efficient interpretation and modification of 3D environments without the overhead of transmitting and processing extensive visual data.

Example embodiments provide an adaptive learning system that seamlessly integrates Artificial Neural Networks (ANNs) with immersive three-dimensional (3D) virtual environments to dynamically generate tailored learning experiences. In one example, a method converts 3D environment states into structured textual data, enabling the ANN to interpret and modify the environment in real-time based on individual learner profiles, instructor inputs, and curricular objectives. This approach significantly reduces bandwidth and computational requirements by processing textual environment data instead of high-volume visual data. Components may include an Environment State Processor that captures and converts environmental data, and an adaptive agent that executes ANN-generated instructions to dynamically adapt the 3D learning environment. The system provides immediate, personalized adjustments based on learner interactions, performance metrics, and optionally, emotional state data, thereby enhancing engagement and educational outcomes. By dynamically creating and customizing 3D learning environments tailored to each learner's unique needs and educational goals, embodiments overcome challenges in existing adaptive learning systems. Such embodiments offer scalable, cost-effective, and accessible solutions across various platforms, ensuring a uniquely personalized and immersive educational experience for every learner.

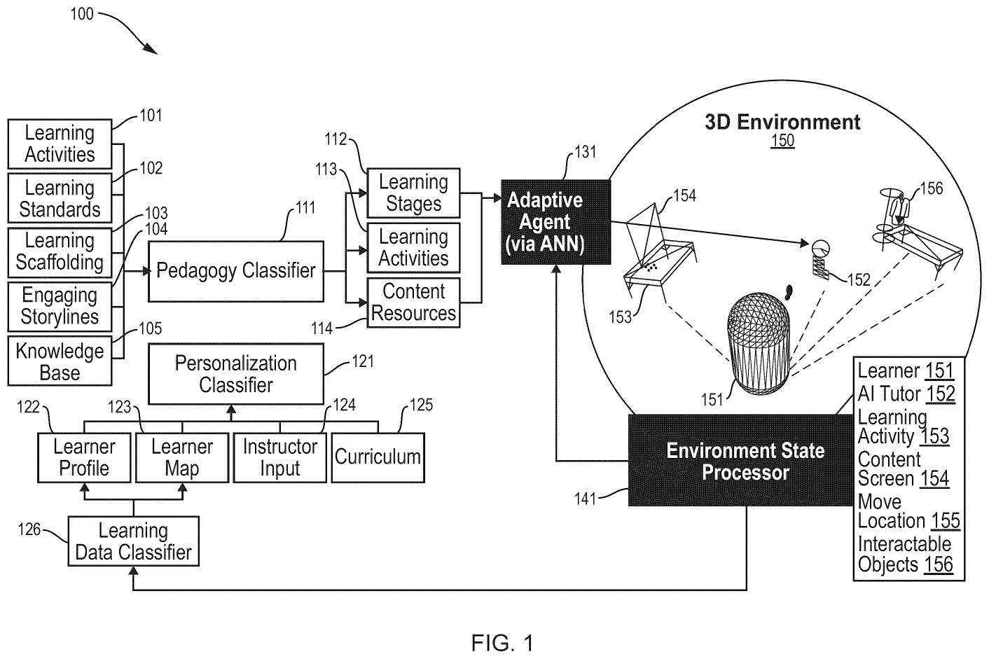

FIG. 1 is a diagram of an adaptive learning system 100 in one embodiment. The system 100 provides a method for real-time generation and adaptation of a three-dimensional (3D) virtual learning environment 150 by capturing the current state of the environment on the client side-including data related to objects 156 and learner 151 interactions—and converting this state into structured textual data via the Environment State Processor 141. This data is processed by the Adaptive Agent 131 powered by an Artificial Neural Network (ANN) to generate adaptation instructions comprising function calls or commands that modify the 3D environment in real-time. The Adaptive Agent 131, embodied as an AI tutor 152, executes these modifications within the virtual environment. By tailoring the learning experience to the individual learner, this method drastically reduces bandwidth requirements and computational costs while creating an engaging 3D learning experience, generated to perfectly fit the learner's needs, level, and interests.

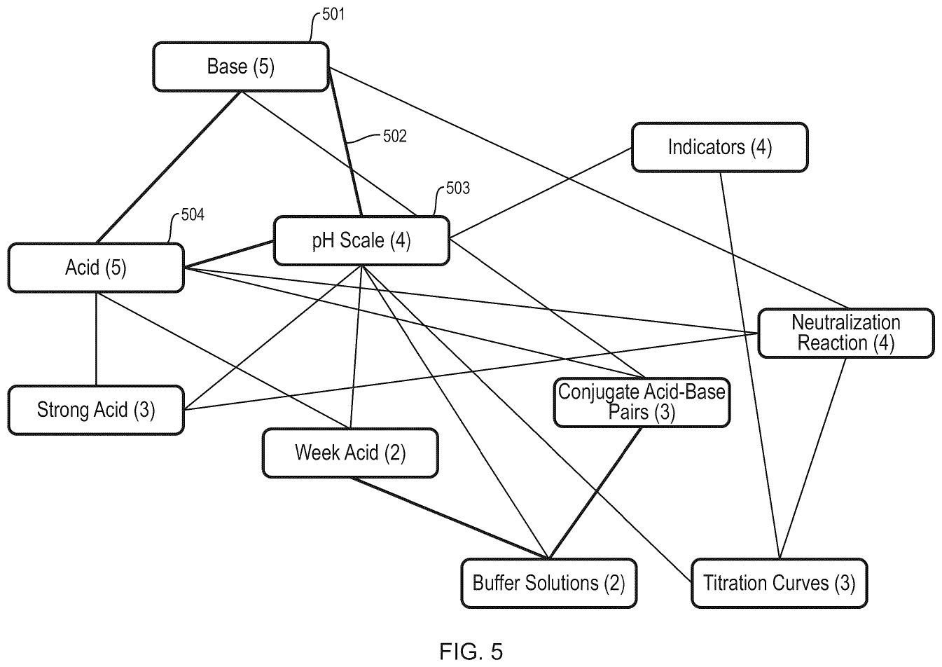

In operation, the system 100 may begin with essential inputs that shape the personalized learning experience. The Learner Profile 122 contains comprehensive information about the learner's characteristics, preferences, strengths, and weaknesses, serving as a foundation for tailoring the educational content. The learner profile is dynamically generated and updated, and can start with ingestion of external data (from sources such as Learning management systems, an initial quiz, learner's history of courses and grades) and it will be continuously updated based on the learner's interaction with and performance in the learning environment. The Learning Map 123 provides a dynamic representation of the learner's current knowledge state and progress across various concepts, allowing the system to identify areas for improvement and growth. And example learning map is described below with reference to FIG. 5. Instructor Input 124 incorporates input from teachers or instructors, ensuring that the automated system aligns with human-guided pedagogical goals. The Curriculum 125 outlines the overall course structure and learning objectives, providing a framework within which personalization occurs.

These inputs feed into the Personalization Classifier 121, a sophisticated component that analyzes and synthesizes the information to generate personalized learning directives. This classifier tailors the learning experience to individual learners by producing specific learning objectives, content preferences, and contextual relevance guidelines. Its output informs the Pedagogy Classifier 111, which combines this personalized information with established educational best practices.

The Pedagogy Classifier 111 draws upon several key resources: Learning Activities 101, a repository of educational tasks and exercises; Learning Standards 102, which provide established benchmarks and criteria; Learning Scaffolding 103, offering supportive structures to assist learners in mastering new concepts; Engaging Storylines 104, which incorporate narrative elements to enhance learner engagement; and a comprehensive Knowledge Base 105. Each Learning Activity 101 is structured with pre-designed interactive elements, including clear objectives, success criteria, progression mechanisms, and embedded hints and guidance systems. These activities are not static entities but flexible frameworks that can be dynamically populated with content.

The Pedagogy Classifier 111 processes these inputs to output Learning Stages 112, which represent a sequence of educational phases designed to optimize the learning process. Each learning stage contains personalized Learning Activities with prefilled personalized learning content. In addition, the Pedagogy Classifier 111 provides relevant Content Resources 114 that ensure that the Adaptive Agent 131 has all the information needed to teach the learning concept.

The Adaptive Agent 131 serves as the central hub of the system, receiving input from the Pedagogy Classifier. This agent is responsible for interpreting the classifiers' outputs and implementing adaptive learning strategies within the 3D Environment 150. The Adaptive Agent dynamically creates and modifies the learning experience in real-time, adjusting content difficulty, presentation style, and pacing based on the learner's performance and, optionally, emotional state. Within the 3D Environment, several key elements come into play. The Learner 151 is represented as a virtual avatar, allowing for immersive interaction. The AI tutor 152, which acts as the interface to the Adaptive Agent, is represented as a floating spherical drone.

The Environment State Processor 141 continuously monitors and analyzes the state of the 3D Environment, capturing data on learner interactions, object positions, and other relevant environmental factors. This component plays a crucial role in converting complex 3D data into a structured textual format that can be efficiently processed by the Adaptive Agent, significantly reducing bandwidth requirements and enabling real-time responsiveness.

Finally, the Learning Data Classifier 126 analyzes the learner's performance and interactions within the learning environment. It processes metrics such as task completion times, accuracy rates, and engagement levels, identifying patterns that indicate mastery or difficulty with specific concepts. This classifier updates the Learner Profile and Learning Map based on new performance data, creating a feedback loop that allows for continuous adaptation and refinement of the learning experience.

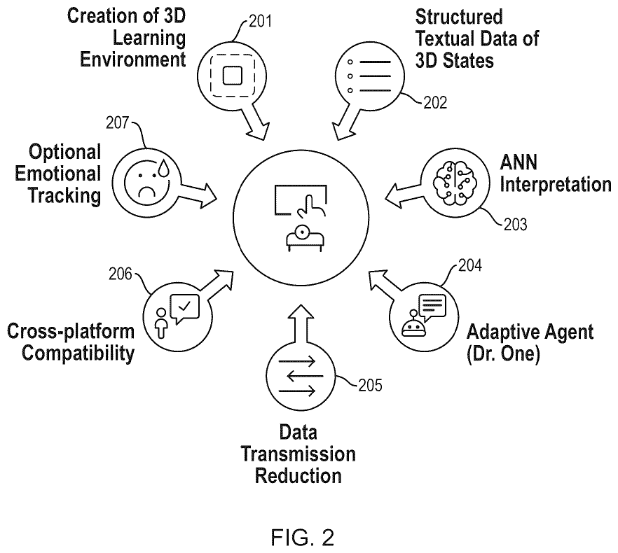

FIG. 2 is a diagram depicting features of an adaptive learning system in one embodiment. With reference to FIG. 1, the system 100 utilizes several key innovations that work together to create an adaptive and personalized 3D learning experience. A significant innovation lies in the ability to generate immersive 3D environments, enhancing learner engagement through interactive 3D simulations 201. As the learner interacts with the environment, the system converts the complex states into structured textual data, which significantly optimizes data processing and reduces bandwidth requirements 202. The Artificial Neural Networks (ANNs) analyze this structured data, enabling sophisticated real-time adaptations that are customized to each learner 203. An Adaptive Agent (AI tutor) acts as the intelligent tutoring interface, interpreting the ANN outputs to provide dynamic, personalized guidance and make real-time adjustments in the 3D environment 204. Data transmission is reduced by sending only essential textual information, leading to bandwidth savings of up to 99%, which ensures smooth performance even in low-bandwidth environments 205. Cross-platform compatibility allows the system to function seamlessly across different devices such as desktops, mobile devices, Virtual Reality (VR), and Augmented Reality (AR), ensuring a consistent and engaging user experience 206. With the user's consent, emotion-tracking can optionally be integrated to further personalize the experience, allowing the system to adapt content pacing and complexity in response to the learner's emotional state 207. Together, these innovations combine to deliver a personalized and adaptive 3D learning experience that evolves in real time to meet the learner's needs 208.

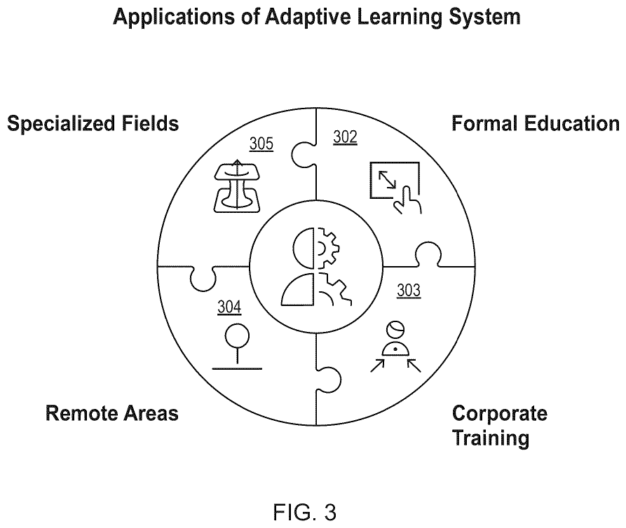

FIG. 3 is a diagram illustrating applications of an adaptive learning system in one embodiment. This figure illustrates the diverse applications of the Adaptive Learning System across various educational and training contexts. Embodiments of the invention can be applied in multiple domains as follows:
a) Formal Education 302: Schools and universities can implement the system to provide personalized, engaging learning experiences without the need for high-bandwidth infrastructure or extensive hardware investments.
b) Corporate Training and Professional Development 303: Organizations can deploy the system for employee training programs, enabling efficient, individualized learning experiences that can be accessed remotely and scaled across multiple locations.
c) Remote and Under-Resourced Areas 304: The bandwidth- and latency-efficient design makes advanced adaptive learning accessible in regions with limited internet connectivity, bridging educational gaps and promoting equitable access to quality education.
d) Specialized Fields 305: Fields such as healthcare, engineering, and scientific research can leverage the system to create complex environment-aware simulations and interactive learning scenarios that adapt to the learner's proficiency level in real-time.

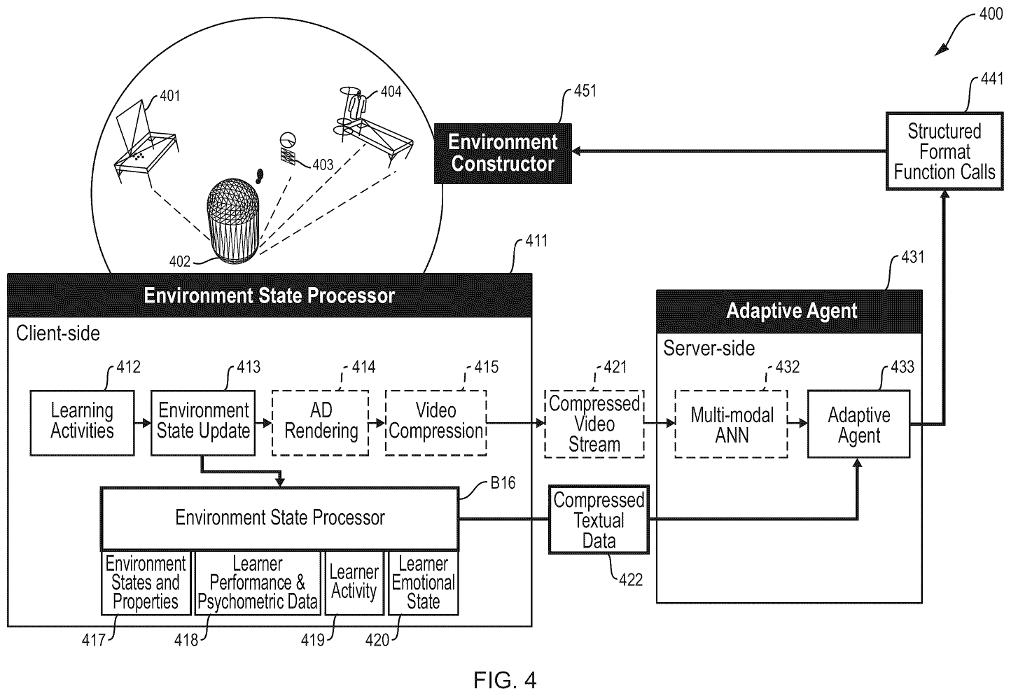

FIG. 4 is a diagram of an adaptation process 400 that may be carried out by an adaptive learning system such as the system 100 described above. The process 400 illustrates an example data flow and interactions between the Environment State Processor, ANN, Adaptive Agent, and the 3D Environment Constructor during a learning session. The components depicted in FIG. 4 may correspond to components of the system 100, as described below.

With reference to FIGS. 1 and 4, adaptive learning system comprises several interrelated components that work collaboratively to capture learner interactions, process data, and adapt the learning environment in real-time. The key components include:
a) Environment State Processor (ESP) 141/411
b) Adaptive Agent 131/431
c) Environment Constructor 451
d) 3D Environment 150/402, which encompasses the Learner 151/402 and Interactable Objects 156/404

On contrast, conventional systems typically employ a Multi-modal Artificial Neural Network (ANN) 432 for processing visual data. This comparison highlights the key differences and advantages of a text-based method over conventional visual processing techniques.

The system 100 can operate on both the client side (learner's device) and the server side. The client side may be responsible for capturing and processing the 3D environment states, while the server side may handle advanced processing and environment adaptation through the ANN. The Environment State Processor (ESP) 141/411 may function on the client side. The ESP continuously captures comprehensive data about the 3D environment and the learner's interactions within it, significantly reducing the need for high bandwidth and extensive server resources. The ESP captures data such as:
a) Positions and properties of relevant objects within the 3D Environment 150/402
b) Dynamic properties like temperature, pH, concentration, acceleration, and speed
c) Learner actions and interactions with objects, including manipulations and movements

This data collection is crucial for creating an accurate representation of the learner's environment, which is necessary for personalized adaptive responses. The ESP 141/411 employs an object detection algorithm that identifies and filters objects based on proximity, interactivity, and relevance to the current learning stage and activity. The Scan Radius defines the area around the learner for object detection, ensuring that only nearby relevant objects are considered, as shown in FIG. 4, where the Learner 402 interacts with the Interactable Object 404.

### Pseudocode Implementation

The pseudocode presented herein is provided as examples to illustrate how embodiments may be configured and programmed to perform the indicated operations. The operation of the object detection algorithm can be understood through the following pseudocode:

```
Function EnvironmentToTextProcessor(filterCriteria, scanRadius):
  player = GetPlayerObject( )
  mainCamera = GetMainCamera( )
  hitColliders = GetCollidersInSphere(player.position, scanRadius)
  nearbyObjects = InitializeEmptyList( )
For each collider in hitColliders:
    entity = GetParentEntity(collider)
    if EntityMatchesFilter(entity, filterCriteria):
      if IsInteractable(entity):
        directionToPlayer = CalculateDirectionToPlayer(mainCamera, entity.position)
        distance = CalculateDistance(player.position, entity.position)
        distanceText = ConvertDistanceToText(distance)
        relativeLocationAngle = CalculateAngle(mainCamera, entity.position)
        relativeLocation = GetRelativeLocationFromAngle(relativeLocationAngle)
        properties = GetObjectProperties(entity)
        physicalProperties = GetDynamicPhysicalProperties(entity)
        objectColor = GetObjectColor(entity)
        contentColor = GetContentColor(entity)
        parentObject = GetParentEntity(entity)
        nearbyObjects.Add(
            CreateObjectInfo(entity, distanceText, relativeLocation, properties,
  physicalProperties, objectColor, contentColor, parentObject)
          )
    SortNearbyObjects(nearbyObjects)
    Return nearbyObjects
```

In the pseudocode above, the function EnvironmentToTextProcessor gathers data about relevant objects within a defined scan radius. It filters entities based on specified criteria and checks if they are interactable and thus relevant. For each relevant object, it calculates its distance and relative location to the player, extracts its relevant properties, and compiles this information into an ObjectInfo data structure.

### Converting Numerical Data to Text

To facilitate efficient processing by the ANN, numerical data such as distances and angles may be converted into textual descriptions. This conversion aids in natural language processing and reduces data complexity. In the example pseudocode below, function ConvertDistanceToText translates numerical distances into descriptive text:

```
Function ConvertDistanceToText(distance):
  If distance <= 1:
    Return “very close”
  Else If distance <= 3:
    Return “close”
  Else If distance <= 6:
    Return “medium distance”
Else:
    Return “far away”
```

Similarly, the function GetRelativeLocationFromAngle determines the relative position of an object based on the angle between the player's forward direction and the object's position, and translates it into a format further aiding the natural language processing:

```
Function GetRelativeLocationFromAngle(angle):
  If angle >= −22.5 and angle < 22.5:
  Return “Front”
Else If angle >= 22.5 and angle < 67.5:
  Return “FrontRight”
Else If angle >= 67.5 and angle < 112.5:
  Return “Right”
Else If angle >= 112.5 and angle < 157.5:
  Return “BackRight”
Else If angle >= 157.5 or angle < −157.5:
  Return “Back”
Else If angle >= −157.5 and angle < −112.5:
  Return “BackLeft”
Else If angle >= −112.5 and angle < −67.5:
  Return “Left”
Else If angle >= −67.5 and angle < −22.5:
  Return “FrontLeft”
Else:
  Return “Unknown”
```

These textual descriptors may enable the ANN to interpret spatial relationships in a text-based NLP format. The descriptors also ensure that relevant objects that are outside the learners viewing area is still accessible to the ANN, e.g. if a chemical experiment starts to overheat at a nearby lab bench behind the learner, the Adaptive Agent is able to “see behind the learner” and proactively guide the learner's focus if appropriate to the current pedagogical approach and learning stage. Such features are not possible with a traditional multi-modal video-streaming based approach.

### Extracting Object Properties

The system 100 gathers detailed properties of objects, including static attributes, dynamic states, and scientific measurements relevant to the learning activity. The function GetObjectProperties extracts properties such as temperature, pH, concentration, and content description:

```
Function GetObjectProperties(entity):
  properties = InitializeEmptyList( )
    // Chemical Properties
  If entity.HasProperty(“Temperature”):
    properties.Add(“Temperature: ” + entity.GetTemperature( ) + “°C.”)
  If entity.HasProperty(“pH”):
    properties.Add(“pH: ” + entity.GetPH( ))
  If entity.HasProperty(“Concentration”):
    concentration = entity.GetConcentration( )
    properties.Add(“Concentration: ” + concentration.value + concentration.unit + “ of ” +
concentration.substance)
  If entity.HasProperty(“Content”):
    properties.Add(“Content: ” + entity.GetContentDescription( ))
  // Interaction States
  If entity.IsHeldByPlayer( ):
    properties.Add(“Held by Player”)
  If entity.HasState(“Explosive”):
    properties.Add(“Warning: Explosive”)
  If entity.HasState(“Reactive”):
    properties.Add(“Reactive with: ” + entity.GetReactiveSubstances( ))
  Return properties
```

For learning involving physics or motion, dynamic physical properties are captured using GetDynamicPhysicalProperties:

```
Function GetDynamicPhysicalProperties(entity):
  physicalProperties = InitializeEmptyList( )
If entity.HasProperty(“Mass”):
  physicalProperties.Add(“Mass: ” + entity.GetMass( ) + “kg”)
If entity.HasProperty(“Velocity”):
  velocityVector = entity.GetVelocity( )
  speed = CalculateMagnitude(velocityVector)
  physicalProperties.Add(“Speed: ” + speed + “ m/s”)
  physicalProperties.Add(“Velocity: ” + FormatVector(velocityVector) + “ m/s”)
If entity.HasProperty(“Acceleration”):
  accelerationVector = entity.GetAcceleration( )
  physicalProperties.Add(“Acceleration: ” + FormatVector(accelerationVector) + “ m/s²”)
If entity.HasProperty(“GravitationalPull”):
  physicalProperties.Add(“Gravitational Pull: ” + entity.GetGravitationalPull( ) + “ m/s²”)
Return physicalProperties
```

### Color Detection

The system 100 may detect the exact color of objects and their contents to enhance interaction and context understanding. This may be achieved through the functions GetObjectColor and GetContentColor:

```
Function GetObjectColor(entity):
  If entity.HasColor( ):
    Return entity.GetColor( )
  Else:
    Return “Unknown”
Function GetContentColor(entity):
  If entity.ContainsProperty(“Liquid”):
    If entity.HasLiquidColor( ):
      Return entity.GetLiquidColor( )
  Return “No Liquid”
```

Integration with Artificial Neural Networks

The structured textual data generated by the ESP is transmitted to the server-side Adaptive Agent 431 via the network, as shown in FIG. 4. The significant reduction in data size compared to transmitting visual data addresses the problem of high bandwidth requirements in existing systems. The Adaptive Agent 431 receives:
a) Compressed Textual Data 422: Structured representations of environment states
b) Learner Performance & Psychometric Data 418: Includes learner interactions and emotional state (if available)
c) Learner Activity 419: Current learning activity and context

### Processing and Output Generation

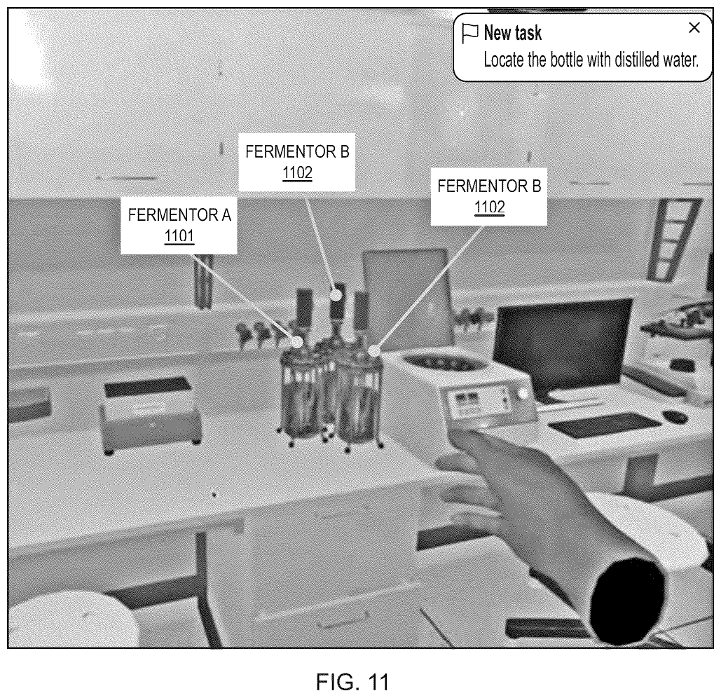

The Adaptive Agent 431 processes the input data to generate adaptive responses, including dialogue and executable function calls. For instance, in the fermenter scenario described below with reference to FIG. 11, the ANN might generate:

```
{
  “dialogue”: “You're observing Fermenter A with a yeast culture at optimal conditions for
fermentation.Remember, the glucose concentration affects the rate of ethanol production.”,
  “functionCalls”: [
    {
      “functionName”: “HighlightObject”,
      “parameters”: {
        “objectName”: “Fermenter A”,
        “color”: “Green”
      }
    },
    {
      “functionName”: “DisplayGraph”,
      “parameters”: {
        “title”: “Ethanol Production vs.Glucose Concentration”,
        “data”: [
          {“glucose”: 5, “ethanol”: 2},
          {“glucose”: 10, “ethanol”: 4},
          {“glucose”: 15, “ethanol”: 6}
        ]
      }
    }
  ]
}
```

The Environment Constructor 451 executes the function calls without intermediate translation, updating the 3D Environment 150/402 in real-time. This direct execution enhances efficiency and responsiveness, addressing the issue of reduced immersion due to slow responses in current systems. The Adaptive Agent 131/431, embodied as and AI tutor 152 in the 3D Environment 150/402, acts as an intelligent tutoring system and facilitates interaction and adaptation by:
a) Parsing the ANN's outputs, distinguishing between dialogue and function calls
b) Providing personalized guidance and feedback to the learner
c) Executing environment changes through communication with the Environment Constructor 451

This seamless integration ensures that the learner receives immediate and relevant support, enhancing engagement and educational effectiveness.

### Technical Implementation Example: Creation of Chemical Experiment Objects

Turning again to FIG. 1, in the adaptive learning system 100, the creation and adaptation of learning activities are driven by the coordination between the Adaptive Agent 131 powered by an ANN, the Pedagogy Classifier, and the Environment Constructor. This example demonstrates how the system dynamically generates a learning activity by creating three chemical experiment objects-beakers with specific chemicals-tailored to the learner's educational needs.

### Scenario: Personalized Chemistry Experiment

Let's consider a learner named Alex, who is studying acid-base reactions in a high school chemistry course. The instructor has provided specific learning objectives focusing on understanding the properties of acids and bases, and how they react with each other. During the thinking activation stage of the learning experience, Alex has shown particular interest in exploring the properties of citric acid found in fruits.

### Step 1: Initialization

At the beginning of the session, the system retrieves Alex's Learner Profile 122 and the relevant curriculum requirements from the Curriculum 125. The Personalization Classifier 121 analyzes this information to determine that a virtual chemistry lab simulation involving acid-base reactions will be most effective for Alex.

### Step 2: Pedagogy Classifier Pre-Populates Learning Activity

The Pedagogy Classifier 111 selects a learning activity template from the Learning Activities A01, pre-populating it with default chemicals for an acid-base titration experiment, such as hydrochloric acid (HCl) and sodium hydroxide (NaOH). The default learning activity includes a titration setup with standard reagents.

### Step 3: The Current State Captured by Environment State Processor

Alex enters the 3D virtual chemistry lab 150. The Environment State Processor (ESP) 141 captures the current state of the 3D virtual environment. At this moment, the environment includes:

Alex's position: Standing near the lab bench.

Objects present in the environment:

Lab bench.

Standard titration apparatus (empty, no reagents yet).

General lab equipment (e.g., pipettes, safety goggles).

The ESP converts this information into structured textual data representing the current environment state.

### Sample Structured Textual Data Generated by ESP:

```
{
  “learnerPosition”: “Near lab bench”,
  “environmentObjects”: [
    {
      “objectType”: “LabBench”,
      “objectName”: “Main Lab Bench”,
      “position”: “Close to the Front”
    },
    {
      “objectType”: “TitrationApparatus”,
      “objectName”: “Standard Titration Setup”,
      “contents”: “Empty”,
      “position”: “Close on Main Lab Bench to the Front Right”
    },
    {
      “objectType”: “Equipment”,
      “objectName”: “Pipettes”,
      “quantity”: 5,
      “position”: “Close on Equipment Rack to the Front Left”
    },
    {
      “objectType”: “SafetyEquipment”,
      “objectName”: “Safety Goggles”,
      “position”: “Close on Equipment Rack to the Front”
    }
    // Additional objects as relevant
  ],
  “learnerInteractions”: { }
}
```

### Step 4: ANN Processes Current State and Learner Profile

The Adaptive Agent 131, powered by the ANN, receives the structured textual data from the ESP along with Alex's Learner Profile 122, and the predefined learning objectives 125. The ANN processes:
a) The current environment state.
b) Alex's position and potential interactions.
c) Alex's interest in citric acid.
d) The default learning activity from the Pedagogy Classifier 111.

### Step 5: ANN Generates Adaptation Instructions

Based on the processing, the ANN determines that to enhance Alex's engagement and align with his interests, the learning activity should be adapted to include citric acid. It generates adaptation instructions, which include function calls to modify the environment by adding new objects (beakers with specific chemicals).

```
          ANN Output:
{
  “dialogue”: “Hi Alex! I see you're ready to explore acid-base reactions.Since you're interested
in citric acid, let's use it in our experiment today. I'll set up the necessary materials for you.”,
  “adaptationInstructions”: [
    {
      “functionName”: “CreateObject”,
      “parameters”: {
        “objectType”: “Beaker”,
        “objectName”: “Beaker A”,
        “contents”: [
            {
                        “chemical”: “Citric Acid”,
                        “chemicalFormula”: “C₆H₈O₇”,
                        “concentration”: “0.1 M”,
                        “volume”: “100 mL”,
                                      “amountInMoles”: “0.010 mol”
                          }
                        ],
                        “totalVolume”: “100 mL”,
        “pH”: 2.2
    },
    “position”: {
      “location”: “On Main Lab Bench”,
    }
  }
},
{
  “functionName”: “CreateObject”,
  “parameters”: {
    “objectType”: “Beaker”,
    “objectName”: “Beaker B”,
    “contents”: {
        “chemicals”: [
        {
              “chemical”: “Sodium Hydroxide”,
              “chemicalFormula”: “NaOH”,
              “concentration”: “0.1 M”,
              “volume”: “50 mL”,
              “amountInMoles”: “0.005 mol”
        }
        ],
        “totalVolume”: “50 mL”,
        “pH”: 13.0
    },
    “position”: {
            “location”: “On Main Lab Bench”,
          }
        }
      },
      {
        “functionName”: “UpdateObject”,
        “parameters”: {
          “objectName”: “Standard Titration Setup”,
          “properties”: {
            “ready”: true,
            “instructions”: “Set up for titration with Beaker A and Beaker B”
          }
        }
      },
      {
        “functionName”: “Display Instructions”,
        “parameters”: {
          “text”: “Use the titration setup to add sodium hydroxide from Beaker B to the citric acid in
Beaker A. Observe the pH changes as you proceed.”
      }
    }
  ]
}
```

### Step 6: Environment Constructor Executes Adaptation Instructions

The Environment Constructor 451 receives the adaptation instructions and executes the function calls, modifying the 3D virtual environment 150 in real-time:
a) CreateObject functions instantiate Beaker A and Beaker B on the lab bench with the specified chemicals.
b) UpdateObject modifies the existing titration apparatus to be ready for the experiment.
c) DisplayInstructions presents guidance to Alex within the virtual environment.
   Step 7: Adaptive Agent Interacts with Learner

The Adaptive Agent 131, through the ANN-generated dialogue, communicates directly with Alex:
a) Provides a personalized introduction to the experiment.
b) Explains the relevance of using citric acid.
c) Guides Alex on how to proceed with the titration.
   Step 8: Learner Interacts with the Environment

As Alex engages with the experiment, he/she may add sodium hydroxide from Beaker B to the citric acid in Beaker A using the titration setup, and observes pH changes using the virtual pH meter.

### Step 9: Environment State Processor Captures Interactions

The ESP 141 continuously monitors Alex's interactions and the environment's state:
a) Records the volume of NaOH added.
b) Tracks pH changes in Beaker A.
c) Notes any deviations from the expected procedure.

### Structured Textual Data of Interactions:

```
{
  “learnerInteractions”: {
    “transferContent”: {
        “toObjectName”: “Beaker A”,
        “fromObjectName”: “Beaker B”,
        “chemicalFormula”: “NaOH”,
        “concentration”: “0.1 M”,
        “addedVolume”: “50 mL”,
        “pH”: 6.0,
        “observationTime”: “2 minutes”
  }
},
“environmentState”: {
  “Beaker A”: {
    “contents”: {
        “chemicals”: [
        {
            “chemical”: “Citric Acid”,
            “chemicalFormula”: “C₆H₈O₇”,
            “concentration”: “0.033 M”,
            “volume”: “150 mL”,
            “amountInMoles”: “0.005 mol”
        },
        {
            “chemical”: “Monosodium Citrate”,
            “chemicalFormula”: “NaC₆H₇O₇”,
            “concentration”: “0.033 M”,
            “volume”: “150 mL”,
            “amountInMoles”: “0.005 mol”
        },
        {
            “chemical”: “Water”,
            “chemicalFormula”: “H₂O”,
            “volume”: “150 mL”
        }],
        “totalVolume”: “150 mL”,
        “pH”: 6.0
                }
      }
    }
  }
}
```

### Step 10: ANN Processes Interactions and Provides Feedback

The Adaptive Agent 131 (ANN) processes the updated structured textual data to determine if any real-time adaptations are needed. For example, if Alex adds NaOH too quickly, resulting in rapid pH changes, the ANN can generate new adaptation instructions.

Example pseudocode for ANN Output for Feedback:

```
{
  “dialogue”: “You're doing great, Alex! Notice how the
  pH is approaching neutral as you add
more base.Try adding the sodium hydroxide slowly to
observe the gradual change.”,
  “adaptationInstructions”: [ ]
}
```

### Step 11: Adaptive Agent Delivers Feedback

The Adaptive Agent 131 communicates the feedback to Alex, helping him understand the experiment's nuances.

### Flexibility in ANN Model Selection

While example embodiments have been tested on OpenAI's GPT-4o models, embodiments can be ANN-agnostic. This approach allows for the integration of alternative ANNs from different providers or custom-developed models, provided they can process the structured textual data and generate outputs in the required formats. This includes, but is not limited to, Gemini, Claude and Llama models.
a) Standardized Interfaces: The communication between the ANNs and the rest of the system utilizes standardized APIs and data formats, facilitating the integration of different models without significant modifications to the system.
b) Compatibility Layer: A compatibility layer abstracts the specifics of the ANN models, handling any necessary data transformation or format conversion to ensure seamless operation.

### Emotion-Tracking Integration

The system 100 may incorporate emotion-tracking capabilities to further personalize the learning experience. Referring again to FIG. 4, emotional state data 420 may be processed on the client-side 420 on the learner's device to ensure privacy. The system 100 may employ a variety of non-invasive methods to ascertain the learner's emotional state, contingent upon obtaining explicit user consent. These methods encompass the analysis of facial expressions captured via standard camera input, and detection of physiological indicators such as muscle tension through integrated sensors.

Facial expression analysis is facilitated by the Environment State Processor 441, which utilizes advanced algorithms, potentially including ANNs or specialized emotion-detection software, to interpret subtle facial cues and discern emotions such as frustration, confusion, joy, or disengagement. Additionally, the system may incorporate sensors capable of measuring muscle tension and other physiological signals, providing further insight into the learner's emotional and physical state. These physiological indicators are processed locally on the client side, ensuring sensitive information remains private and is only analyzed with the user's explicit consent.

The Adaptive Agent 432 utilizes the aggregated emotional data to make real-time adjustments to the learning environment. For instance, if facial expression analysis and physiological data indicate that the learner is experiencing frustration, the Adaptive Agent may reduce the difficulty level of tasks, adjust the pacing of content delivery, or introduce supportive dialogue aimed at alleviating negative emotions. Conversely, signs of boredom or disengagement may prompt the system to introduce more interactive elements or increase the complexity of challenges to re-engage the learner.

By incorporating diverse sources of emotional data and leveraging sophisticated processing techniques, the emotion-tracking integration enhances the system's ability to deliver a tailored and empathetic learning experience. This capability distinguishes example embodiments from prior adaptive learning technologies, offering a more nuanced and comprehensive approach to personalization that addresses both the intellectual and emotional dimensions of learning.

### Security and Privacy Measures

The system 100 may incorporates robust security frameworks and privacy protections, such as TLS/SSL for data in transit and AES-256 for data at rest, and implements role-based permissions and secure authentication mechanisms. For regulatory compliance, it also adheres to data protection laws such as GDPR and CCPA, and provides mechanisms for user consent, data access requests, and data deletion. Users have control over their data preferences and can opt-in or out of certain features, such as optional emotion-tracking.

### Scalability

The system supports horizontal scaling to accommodate multiple learners simultaneously without compromising performance. This may be achieved through utilizing cloud services and distributed computing resources, as well as through efficient resource allocation and load balancing.

### Scientific Data Interpretation

The Artificial Neural Network (ANN) implementing the adaptive agent 131 may undergo extensive training using diverse datasets that encompass a wide range of scientific measurements, physical properties, and dynamic interactions.

### Example System Workflow Summary

With reference to FIGS. 1 and 4, an example workflow may be as follows:
a) Initialization: The system retrieves the learner's profile 122 and initializes the session. Learning objectives are personalized based on the learner's needs and curriculum requirements 125.
b) Client-side Processing: The ESP 141/411 captures and processes the environment state on the client side. Data includes object positions, properties, interactions, and dynamic states.
c) Data Transmission: Structured textual data (Compressed Textual Data 422) is sent to the server-side Adaptive Agent 431 via the network.
d) ANN Processing: The Adaptive Agent 431 processes and textual data to generate adaptive responses.
e) Adaptive Agent Execution: The Adaptive Agent 431 interprets the ANN's outputs, distinguishing between dialogue and function calls. It communicates with the Environment Constructor 451 to execute environment changes.
f) Environment Update: The Environment Constructor 451 updates the 3D Environment 150/402 in real-time, modifying scenarios, objects, or challenges based on the ANN's output.
g) Continuous Interaction: The system operates within a continuous feedback loop, ensuring the learning experience remains personalized and responsive throughout the session.

### Benefits and Advantages

Example embodiments provides a unique and non-obvious approach to generating and delivering personalized education through an adaptive learning system that integrates immersive 3D environments with advanced artificial intelligence. By processing 3D environment states on the client-side and converting them into structured textual data, the system addresses significant challenges in bandwidth usage, server processing costs, and environmental understanding.

By streamlining data processing and leveraging structured textual data, the system ensures efficient communication between the client-side and the server-side components. The integration of the Environment State Processor 141/411 and Adaptive Agent 131/431 allows for intelligent interpretation and adaptation, providing personalized guidance and modifying the virtual environment in real-time.

The system 100 may prioritize learner engagement, educational effectiveness, and technological efficiency, representing a significant advancement in adaptive learning systems. By incorporating comprehensive security and privacy measures, it addresses user concerns and complies with regulatory standards. The modular and scalable architecture facilitates easy integration of new technologies, components, and features, ensuring longevity and adaptability in the rapidly evolving field of educational technology and Artificial Neural Networks.

As shown in FIG. 1 and further detailed in FIG. 4, the system 100 dynamically generates and modifies a personalized 3D learning environment for each user. The Adaptive Agent 131 (431 in FIG. 4), guided by the ANN's processing of structured textual data, executes real-time modifications to the virtual environment 150. These modifications may include dynamically creating, altering, or removing virtual objects (401, 402, 403, 404) based on the learner's interactions and performance; adjusting the complexity and layout of the 3D environment to match the learner's skill level and learning objectives; and introducing personalized learning activities 153, challenges, and interactive elements 156 tailored to the individual's learning style and preferences. The system's ability to create highly customized 3D learning spaces enables a level of personalization previously unattainable in adaptive learning technologies.

The approach to processing 3D environment states as structured textual data 422 significantly reduces latency and computational overhead, enabling immediate responsiveness to learner actions, with the environment adapting in real-time to provide timely feedback and guidance; seamless transitions between different learning activities or difficulty levels without disrupting the user experience; and dynamic adjustment of content presentation, including the ability to switch between visual, auditory, and kinesthetic learning modalities based on real-time performance data.

By translating complex 3D environment states into compact textual representations through the Environment State Processor 411, the system 100 achieves up to 99% reduction in data transmission requirements compared to traditional methods of transmitting visual data or high-resolution images 421, increased accessibility for users in areas with limited internet connectivity, and improved scalability. The architecture of example embodiments supports a wide range of devices, including desktop and laptop computers, tablets and smartphones, Virtual Reality (VR) headsets, and Augmented Reality (AR) devices, ensuring a consistent and coherent learning experience across different hardware.

This cross-platform compatibility facilitates integration into various educational settings and supports both on-site and remote learning models. fermenter The system's ability to create highly personalized and responsive 3D learning environments contributes to improved educational outcomes. This is achieved through increased learner engagement due to the immersive and interactive nature of the 3D environment, more effective knowledge reinforcement, and targeted interventions and support. In summary, example embodiments represent a significant advancement in adaptive learning technology, addressing critical challenges in existing systems while opening new possibilities for engaging, effective, and accessible educational experiences through personalized 3D learning environments.

### Technical Innovations and Advantages

Example embodiments introduce several groundbreaking technical innovations that collectively address longstanding challenges in immersive adaptive learning technologies. By leveraging a method of continuously converting three-dimensional (3D) virtual environment states into structured textual data, the system enables Artificial Neural Networks (ANNs) to understand, interpret, and modify virtual environments in real time. This approach significantly reduces bandwidth consumption and computational costs and enables a fully adaptive and personalized interactive learning experience. The key technical innovations include:

Conversion of 3D Environment States into Structured Textual Data: The system 100 circumvents traditional limitations of 3D data processing by converting 3D environment states into structured textual data that encapsulates essential information. This drastically reduces bandwidth usage, enabling efficient data transmission and enhancing system efficiency across various network conditions. Client-side processing helps reduce the need for high data transfer, while structured textual representation ensures lightweight but comprehensive transmission.

Direct Integration of ANNs with Virtual Environments: Example embodiments can integrate ANNs directly with virtual environments by enabling them to understand structured textual representations. This allows the ANN to generate executable function calls in real time, which directly modify the environment without intermediary processes, thus streamlining adaptation and enhancing scalability. The elimination of intermediary translation layers reduces computational overhead and provides greater responsiveness.

Adaptive Agent as an Intelligent Tutoring System: The Adaptive Agent, serves as an intelligent tutoring interface, interpreting ANN outputs to execute complex, real-time modifications within the 3D environment. It facilitates personalized interaction, adjusts content dynamically based on learner responses, and tracks active learning stages to provide appropriate pedagogical guidelines, creating dynamic learning paths that are personalized to learner needs.

Integration of Multiple Adaptive Artificial Neural Networks (AANs): The system uses multiple AANs to ensure effective adaptation at each learning stage. The Personalization Classifier analyzes learner data, such as performance metrics and interaction styles, to personalize the content appropriately. The outputs of the Personalization Classifier are handed off to the Pedagogy Classifier, which evaluates the instructional needs of the learner based on educational principles and learning objectives. Finally, these insights are passed onto the Adaptive Agent, and AI tutor, which uses this information to modify the 3D environment, ensuring that the learning experience is pedagogically sound and customized to the individual's needs.

Selective Relevant Object Compression for Bandwidth Optimization: The Environment State Processor analyzes the 3D learning environment and compresses only objects directly relevant to the learner's current activity. By focusing on selective compression and dynamic adaptation, unnecessary data transmission is avoided, allowing the system to be bandwidth-efficient while retaining adaptability and accessibility, especially in low-bandwidth conditions.

Integration of Emotion-Tracking (Optional Enhancement): Embodiments may optionally include emotion-tracking algorithms that analyze non-invasive indicators of the learner's emotional state, such as facial expressions and interaction patterns. This data is used to adapt content delivery, adjust difficulty levels, and personalize interactions in response to the learner's emotional needs, enhancing learner engagement and retention.

Dynamic Creation of Virtual Objects: The system 100 can dynamically create 3D virtual objects on the fly in response to learner input. This key innovation allows the environment to generate context-specific objects as needed, such as tools, equipment, or educational aids, providing a highly interactive and responsive learning experience. Safety equipment, like a glove box or goggles, is an example of objects that can be generated in real time to enhance learner engagement and accommodate different learning scenarios.

Modular and Scalable System Design: The architecture can be modular and scalable, allowing easy integration of new technologies and updates to system components. This component-based architecture supports scalability through cloud services and distributed computing resources, ensuring that the system can accommodate increasing numbers of users while enabling interoperability with other systems, such as Learning Management Systems (LMS).

Cross-Platform Compatibility and Adaptivity: The system 100 can be fully compatible across multiple platforms, including desktops, mobile devices, VR, and AR devices. Through responsive design and device-specific optimizations, the system ensures consistent performance and a unified user experience. Learner progress and system functionality remain synchronized, allowing seamless transition between different devices.

Bandwidth and Latency Optimization for Real-Time Adaptation: The system 100 can significantly reduce bandwidth by transmitting only essential textual information rather than visual data, resulting in up to 99% bandwidth reduction compared to traditional systems. This allows real-time adaptations even under limited network conditions, thus facilitating immersive learning in remote or bandwidth-constrained locations.

Intelligent Learning Stage and Learning Activity Guidance: The Adaptive Agent may continually provide the ANN with the context of the currently active learning stage and the corresponding learning activity. By keeping track of the learner's progress and offering stage- and activity-dependent pedagogical guidance, the system ensures that learning objectives are consistently aligned with educational best practices, further enhancing personalization and learning objective effectiveness.

Unified User Experience with Immersive Interactivity: Through the integration of various components, including the ANN, AI tutor, and the structured environment, learners engage in a highly immersive and interactive 3D environment that is continually adapted in real time to their preferences, actions, and learning goals. The combination of interactivity, emotion tracking, dynamic object creation, and personalized guidance creates a fully responsive educational experience that is more effective than conventional adaptive systems in terms of learning outcomes, computational load, internet bandwidth and overall accessibility.

These innovations collectively provide a scalable, responsive, and immersive 3D learning experience tailored to individual needs, revolutionizing the way learners engage with complex educational content and simulations.

FIG. 5 depicts an example Learning Map, which is a dynamic representation of a learner's knowledge state in a specific domain, in this case, acid-base chemistry. The map comprises interconnected nodes representing key concepts, such as Acid 504, Base 501, and pH Scale 503. The connections between nodes 502 indicate relationships between concepts and the weight of the connections indicate how closely related the concepts are. The numbers in parentheses represent mastery levels. This visual structure allows the adaptive learning system to assess the learner's current understanding, identify knowledge gaps, and create personalized learning paths. By tracking a learner's progress across various concepts, the Learning Map enables the system to determine the most effective next steps in the learning journey, ensuring a tailored and effective educational experience.

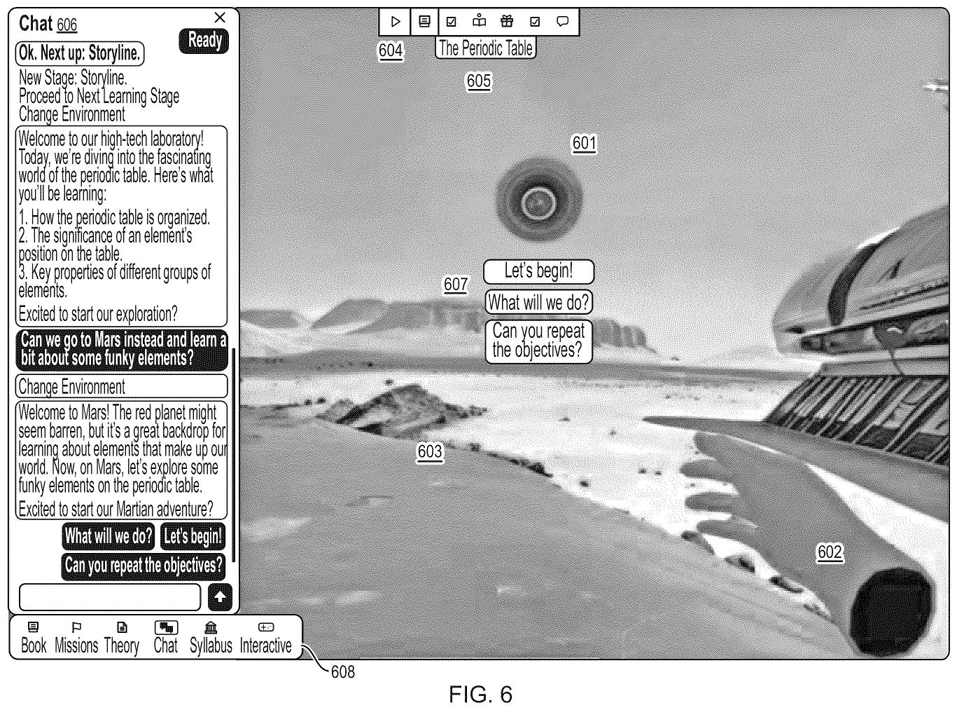

FIG. 6 illustrates a user interface featuring an adaptive agent and the 3D Environment from the learner's 602 point of view. The Adaptive Agent generates and/or selects from available 3d scenes (expanded continuously) a theme that fits the learning profile and any inputs or constraints given by the instructor. In this example the Adaptive Agent chooses a Mars theme, generates a 3D interactive scene on Mars where the learner 703 learns about the periodic table 705. The AI tutor adapts the environment and learning objectives based on the learner's request to explore elements on Mars, demonstrating its ability to dynamically adjust the learning experience. The chat interface allows both text and natural voice conversations with the AI agent. 606 and interaction options 607 show how the AI tutor facilitates real-time communication and engagement with the learner, tailoring the educational journey to individual preferences and inputs. In addition to this interface the learner can communicate with the AI tutor via voice input using the device's microphone. Learning Activities 153 manifest as objects in the 3D Environment where the learner needs to complete interactive tasks and exercises. The Content Screen 154 can be used for 2D learning activities. Move Locations 155 define areas where the learner can navigate, and Interactable Objects 156 provide 3D elements that learners can manipulate or interact with, enhancing the hands-on learning experience.

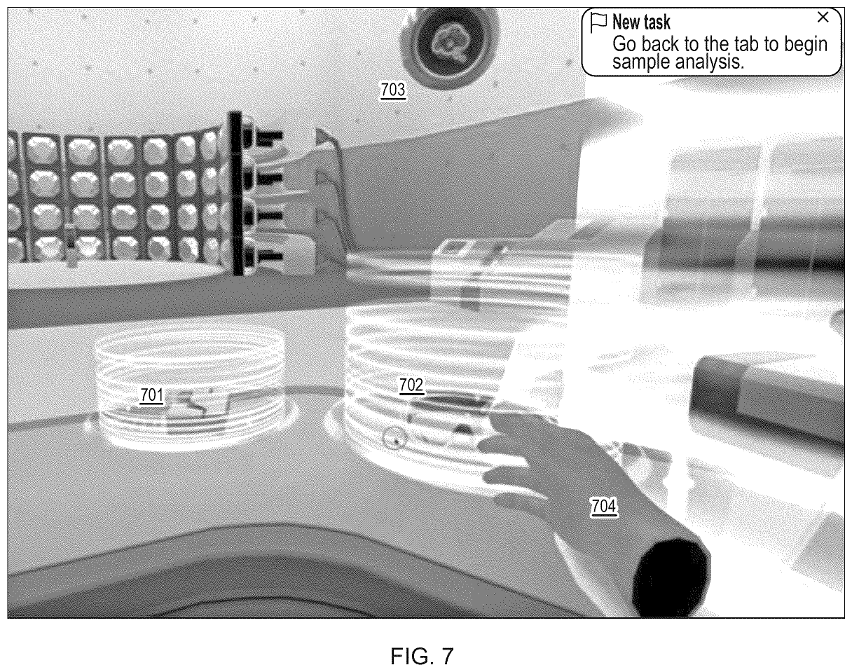

FIG. 7 illustrates a user interface featuring generation and manipulation of objects in real-time, where the AI tutor 703 instantly generates virtual objects like a glove box 701 and goggles 702 in response to the learner's request. The learner's interaction, shown by the hand 704 reaching towards these newly created objects, emphasizes the ANN's ability to assess the context and adapt the environment for immediate and safe learning, showcasing the system's adaptability and interactivity. This applies to any objects including more complex elements like laboratory equipment, medical equipment, or virtual characters.

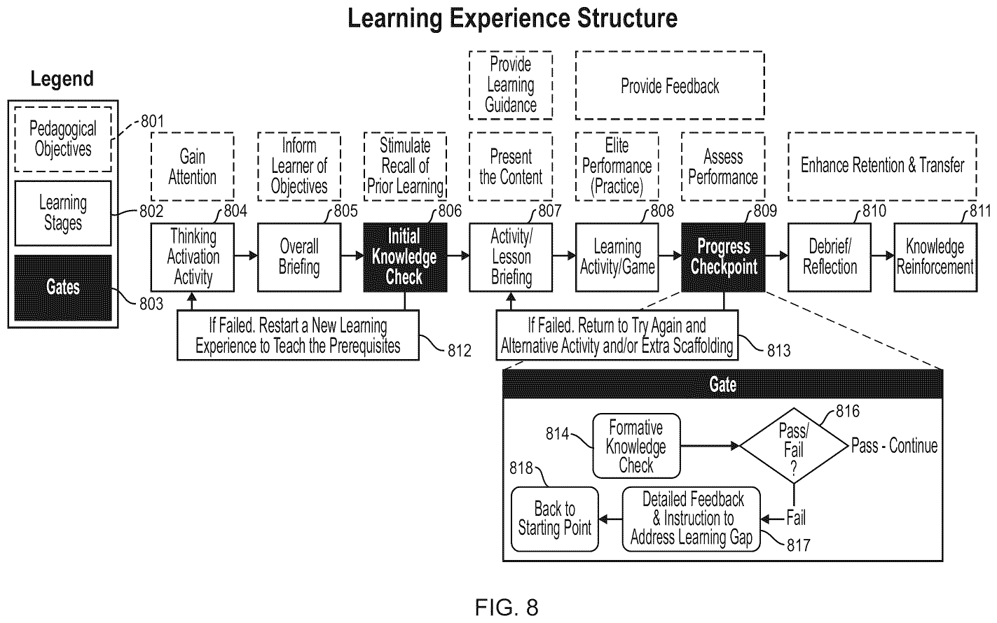

FIG. 8 illustrates the Learning Experience Structure, which outlines the sequential stages of the learning process within the system. The structure is organized into two main layers: Pedagogical Objectives 801 and Learning Stages 802, with Gates 803 serving as critical checkpoints.

The learning journey begins with the Thinking Activation Activity 804, designed to engage the learner's mind and establish context. This is followed by the Overall Briefing 805, where learning objectives are presented. The Initial Knowledge Check 806, a gate component, assesses the learner's existing understanding.

The core of the experience comprises the Activity/Lesson Briefing 807, followed by the Learning Activity 808. These stages are where the system's personalization capabilities are most prominent, with personalized learning activities and real-time adjustments based on learner performance and engagement.

Progress Checkpoint 809, another gate, evaluates the learner's understanding before advancing. If a learner struggles, the system can return them to try again with alternative activities or extra scaffolding 813. The experience concludes with Debrief/Reflection 810 and Knowledge Reinforcement 811 stages, ensuring long-term retention.

The Gate process 814-818 is crucial for maintaining learning efficacy. It includes a Formative Knowledge Check 814, followed by a Pass/Fail decision point 816. Learners who fail receive Detailed Feedback & Instruction 817 before returning to the Starting Point 818.

This structure ensures that learners master each concept before progressing, with built-in mechanisms for additional support and alternative learning paths when needed. The design emphasizes continuous assessment, immediate feedback, and adaptive instruction, aligning with best practices in educational psychology and personalized learning.

This interconnected system of components works in concert to deliver a highly personalized, adaptive learning experience that continuously evolves based on the learner's performance, emotional state, and learning needs, all while aligning with established educational objectives and optimizing computational resources.

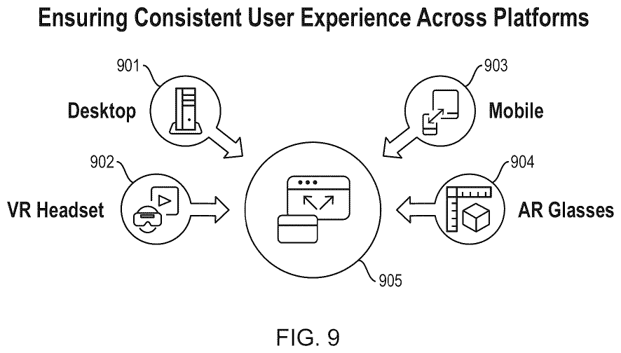

FIG. 9 is a diagram illustrating cross-platform compatibility in one embodiment. As shown here, embodiments may be configured to function consistently across various devices and platforms, including desktops 901, mobile devices 903, VR headsets 902, and AR devices 904. The user interface furthermore adapts to different screen sizes and input methods, ensuring a seamless experience

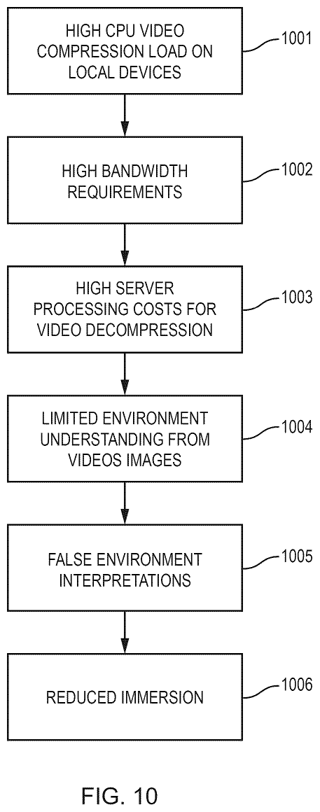

FIG. 10 is a diagram illustrating limitations of certain learning systems. Three-dimensional (3D) immersive learning environments offer a more engaging and interactive educational experience compared to traditional two-dimensional solutions. However, current 3D adaptive learning systems face several critical challenges that limit their effectiveness and widespread adoption. As illustrated in FIG. 10, these limitations form a chain of interconnected issues that collectively contribute to reduced overall effectiveness of existing 3D learning platforms.

High CPU video compression load on local devices 1001 poses a significant initial obstacle. Current systems often require substantial processing power on the user's device to compress and transmit video data, which can lead to performance issues, especially on lower-end devices. This compression challenge directly contributes to high bandwidth requirements 1002, as even compressed video data consumes significant network resources. This limits accessibility for users in areas with poor internet connectivity and can result in laggy or interrupted learning experiences. The need to decompress and process this video data leads to high server processing costs 1003. Educational institutions face scalability challenges due to the substantial computational resources required to handle real-time processing of complex visual data from multiple users simultaneously.

Limited environment understanding from video images 1004 is another key concern. Systems dependent on visual data streams often struggle to comprehend the full context of the learner's environment, leading to incomplete or inaccurate adaptations. Video data alone may not capture all relevant aspects of the learning environment or the learner's interactions. This limited understanding can result in false environment interpretations 1005. Misunderstandings of the learner's actions or environment can lead to inappropriate adaptive responses, potentially causing confusion or frustration for the learner.

Ultimately, these cascading issues culminate in reduced immersion 1006. The combination of device performance issues, network latency, limited environmental understanding, and potential misinterpretations all detract from the seamless, engaging experience that 3D learning environments aim to provide.

These interconnected challenges highlight the need for innovative approaches to overcome the limitations of current 3D adaptive learning solutions and fully realize the potential of immersive educational technologies.

Example embodiments address the above challenges by providing a method of processing 3D environment states and converting them into structured textual data. This innovative approach offers several significant advantages:
a) Reduced Local Device Load: By converting 3D environment states into structured textual data rather than compressing video, the system significantly reduces the computational burden on local devices 1001. This allows the system to function efficiently on a wider range of hardware, including lower-end devices.
b) Bandwidth Efficiency: Transmitting compact textual data instead of compressed video streams dramatically reduces data transmission requirements, directly addressing the high bandwidth requirements 1002. This enhanced efficiency enables learners with limited internet connectivity to access advanced adaptive learning experiences, promoting wider adoption and inclusivity.
c) Lower Server Processing Costs: With the bulk of environment processing done on the client side, the computational load on servers is minimized, addressing the high server processing costs for video decompression 1003. This approach allows for cost-effective scalability, enabling the system to accommodate more users without proportional increases in operational costs.
d) Comprehensive Environmental Understanding: The structured textual data format allows for a complete representation of the environment, including objects and interactions not limited by video frames. This addresses the limited environment understanding from video images 1004, providing improved context awareness and more precise adaptations.
e) Accurate Interpretation: Textual representations eliminate visual ambiguities, reducing the risk of false environment interpretations 1005. This leads to more reliable adaptive responses, enhancing the learning experience and preventing learner confusion due to misinterpretations.
f) Enhanced Immersion: By significantly reducing data size, processing requirements, and transmission delays, the system maintains real-time responsiveness, addressing the reduced immersion 1006 problem. Faster processing times allow for immediate system responses and real-time adaptations, preserving the flow of the learning experience.

By overcoming these significant challenges, example embodiments provide a more efficient, scalable, and effective adaptive learning system. This method results in a superior learning experience that is more accessible, cost-effective, and engaging for learners across diverse settings, while also addressing privacy concerns by reducing the need for continuous video transmission.

### Data Structure for Object Information

FIG. 11 illustrates a user interface featuring a laboratory environment in one embodiment. An ObjectInfo data structure is created to store all the collected information about each object. This structured data enables efficient transmission and processing by the ANN.

Consider the example of fermenters in a virtual laboratory, depicted in FIG. 11 with Interactable Objects 156. The LESP captures properties of each fermenter:
a) Fermenter A 1101: Yeast culture at 30° C., pH 5.5, 15% glucose concentration
b) Fermenter B 1102: Bacterial culture at 37° C., pH 7.0, 5% protein concentration
c) Fermenter C 1103: Algal culture at 25° C., pH 8.0, high lipid content

The ObjectInfo for Fermenter A may be:

```
{
  “objectName”: “Fermenter A”,
  “distance”: “very close”,
  “relativeLocation”: “FrontLeft”,
  “properties”: [
    “Temperature: 30° C.”,
    “pH: 5.5”,
    “Concentration: 15% glucose”,
    “Content: Yeast culture”,
    “Volume: 100 L”
  ],
  “physicalProperties”: [ ],
  objectColor”: “Silver”,
  “contentColor”: “Cloudy”,
  “parentObjectName”: “Fermentation Lab”
}
```

This representation enables the ANN to understand the relevant context and provide appropriate adaptive responses, while also dramatically reducing the amount of data and context sent to the ANN, by limiting it to only the relevant context.

### Bandwidth Optimization Strategies

The system furthermore employs several strategies to optimize bandwidth usage:

Filtered Data Transmission: By processing data on the client-side and transmitting only essential structured textual data (Compressed Textual Data 422), the system significantly reduces internet bandwidth consumption. This contrasts with traditional systems that rely on transmitting large visual data streams (Compressed Video Stream 421), as shown in Table 1.

Adaptive Synchronization: Furthermore, data synchronization frequency adjusts based on whether the changes to the 3D environment are relevant to the current learning stage and activity. Every second, multiple environment change events are automatically triggered by the 3D environment 413, and the ESP 416 determines if those changes are relevant. If relevant, it automatically triggers the compression of textual data 422 and transmits to the Adaptive Agent 433. This dramatically reduces the frequency of data transmission compared to the traditional video-based streaming 421 approach, which relies on a continuous video data stream.

### Example of Selective Object Compression

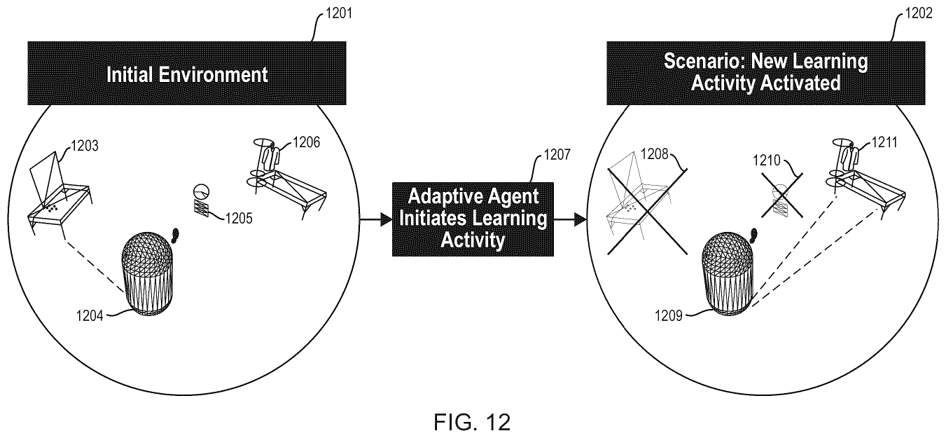

FIG. 12 illustrates operation of an environment state processor, demonstrating how the system 100 may optimize bandwidth usage through selective object compression. In this scenario, Alex, an electrical engineering student, is working on a circuit design module within the adaptive learning environment.

Initially, as shown in 1201, the virtual environment contains multiple objects: a table 1203, the learner avatar 1204, the Adaptive Agent 1205, and lab equipment 1206. This represents the full range of objects that could potentially be rendered in the 3D space.

When the Adaptive Agent initiates a new learning activity 1207, the system's Environment State Processor Algorithm assesses the relevance of each object to the current task. As depicted in 1202, the algorithm determines that certain objects, such as the table 1208, are not essential for the current learning activity and filters them out.

The resulting filtered environment state 1202 retains only the objects directly relevant to Alex's circuit design task: the learner avatar 1209 and the essential lab equipment 1211. This selective processing and transmission of only relevant objects significantly reduces bandwidth usage while maintaining the integrity of the learning experience.

By focusing the system's resources on rendering and updating only the essential elements, Alex benefits from a highly responsive learning environment. This optimization allows the system to adapt to his actions in real-time, even in situations where bandwidth might be limited. The selective object compression ensures that Alex can engage with a dynamic, interactive learning experience without unnecessary data slowing down the system's performance.

### Example Process: Chemistry Course

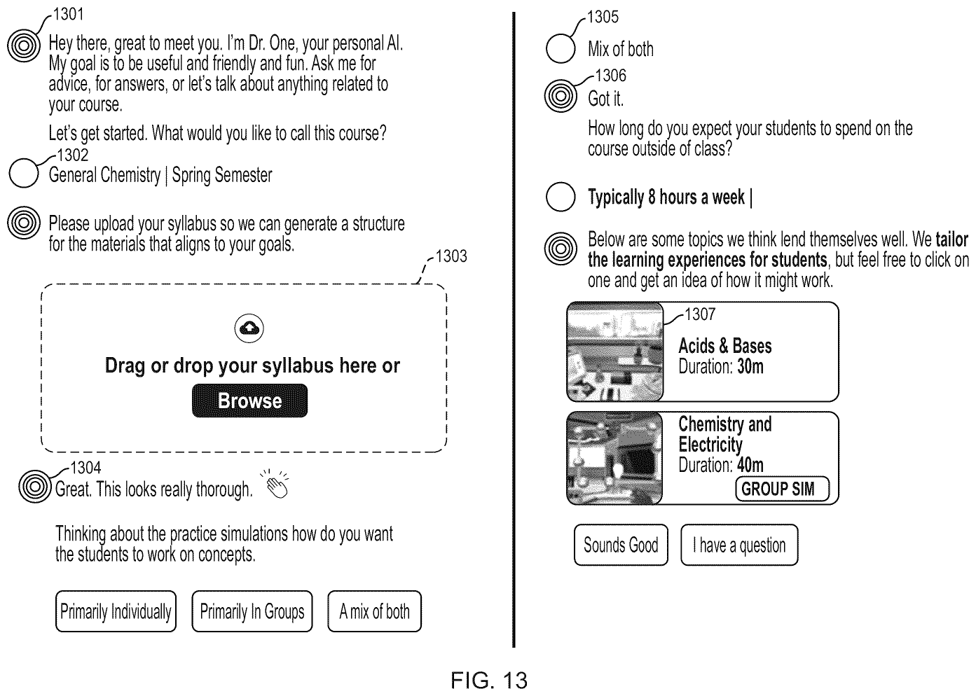

FIGS. 13-15 illustrate an example process of preparing and providing an interactive course to a student, which may be performed by the system 100 through interaction with an instructor and a learner.

FIG. 13 illustrates a user interface featuring interaction with an instructor. In this example, the process begins with an instructor setting up a course using the adaptive learning system. As shown in FIG. 13, the instructor interacts with the Course Facilitation Agent, and AI tutor referring to itself as “Dr. One” (1301), which engages the instructor in a conversational setup process.
a) Initial Interaction: The Course Facilitation Agent prompts the instructor to provide essential information about the course structure and requirements. The instructor names the course “General Chemistry I|Spring Semester” (1302) and uploads the course syllabus (1303).
b) Defining Learning Approaches: the AI tutor inquires about the preferred learning approach for practice simulations (1304). The instructor responds with “Mix of both” (1305), indicating a desire for a combination of individual and collaborative simulations.
c) Setting Study Expectations: The agent further asks about the expected out-of-class study time (1306), and the instructor specifies “8 hours per week.”

This interactive setup process showcases the system's ability to efficiently gather detailed course parameters, ensuring that the adaptive learning environment aligns with the instructor's objectives and pedagogical strategies.

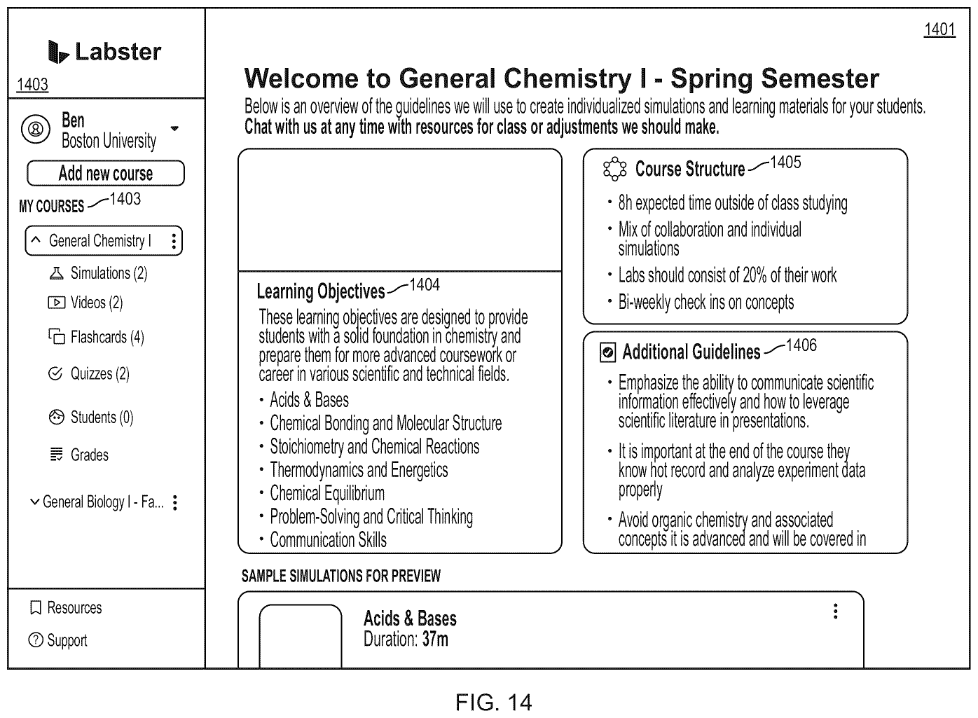

FIG. 14 illustrates a user interface featuring the course configured as described above with reference to FIG. 13. Here, the completed course setup is displayed to a user such as a student of the class:
a) Welcome Page: The welcome page for “General Chemistry I-Spring Semester” (1401) features a 3D rendering of a virtual chemistry lab (1404), providing an immersive visual context for the learners.
b) Course Structure: The course structure (1405) reflects the information gathered during the setup process, including the 8-hour weekly study expectation and the mix of collaborative and individual simulations.
c) Learning Objectives and Guidelines: The learning objectives (1404) and additional guidelines (1406) are clearly outlined, incorporating the instructor's preferences and syllabus content.
   This course creation process demonstrates the system's ability to translate instructor inputs into a structured, personalized learning environment tailored for each learner on an individual basis. The Course Facilitation Agent ensures that the resulting adaptive learning experience aligns with both the instructor's goals and the system's advanced personalization capabilities.

### Learner Profile and Personalization

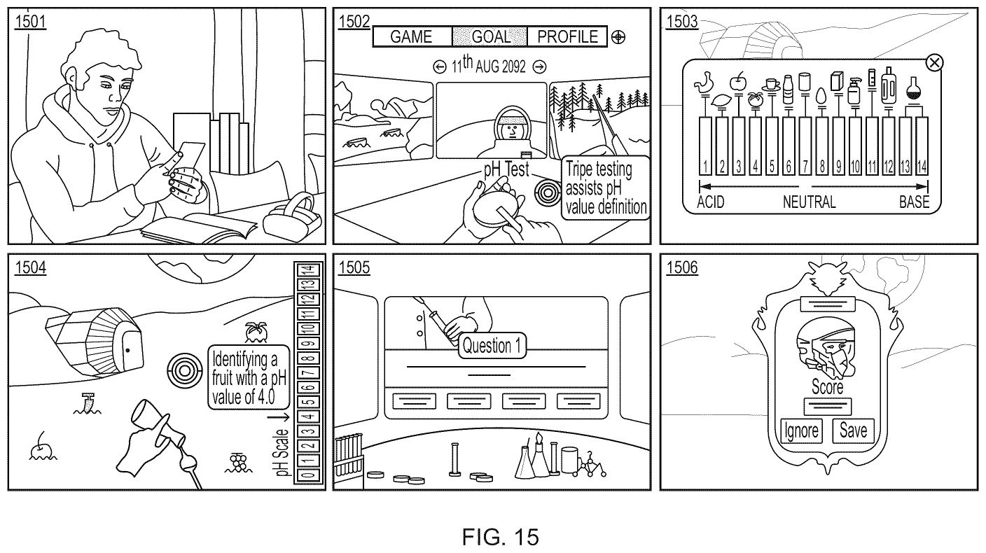

FIG. 15 illustrates a scenario of a user interaction with the adaptive learning system 100. In this scenario, the user is a learner named Tom. FIG. 15 depicts Tom's personalized learning experience as he engages with the system via a mobile device (1501). The adaptive learning system's cross-platform compatibility allows access through various devices, including smartphones, tablets, VR/AR headsets, and computers.

The system utilizes information from Tom's learner profile, stored in the Personalization Classifier, to tailor the learning experience to his background and interests. Below are the details of Tom's learner profile, as shown in Table 1:

TABLE 1
Learner Profile

| Field | Data Type | Description | Value |
|---|---|---|---|
| Name | String | Name of the learner (or | Tom |
| | | alias / ID) | |
| Age | Integer | The age or age interval of | 17 |
| | | the learner | |
| Grade | String | The current grade or level | 12th Grade |
| | | of the learner | |
| Subjects of Interest | List | List of subjects the learner | [Math, Chemistry] |
| | | is interested in | |
| Past Academic Records | List | Historical academic | [B in 10th, A in 11th] |
| | | performance data | |
| Achievements | List | Awards or honors received | [Math Olympiad Winner] |
| | | by the learner | |
| Strengths | List | Strong skills or attributes | [Analytical, Teamwork] |
| | | of the learner | |
| Weaknesses | List | Areas needing | [Public Speaking] |
| | | improvement | |
| Learning Style | String | Preferred learning method | Visual Learner |
| | | of the learner | |
| Declared Major | String | Major chosen by the | Computer Science |
| | | learner (if applicable) | |
| Career Trajectory | String | Learner's desired or | Software Developer |
| | | planned career path | |
| Interests | List | List of learner interests for | Space, Gaming, Ocean |
| | | personalization | |

As shown in Table 1, Tom is a 17-year-old 12th-grade student with interests in math, chemistry, space, gaming, and the ocean. He is an avid gamer and plans to major in computer science, aiming for a career as a software developer.

The system references Tom's Learning Map, which includes his mastery levels of various chemistry concepts, detailed in Table 2, and the relationships between those concepts, shown in Table 3. The weights of Table 3 indicate the closeness of relationships between objects.

TABLE 2
Learning Map Nodes

| Concept | Mastery Level | Last Practiced Date |
|---|---|---|
| Acid | 5 (Expert) | Sep. 10, 2024 |
| Base | 5 (Expert) | Sep. 10, 2024 |
| pH Scale | 4 (Proficient) | Sep. 8, 2024 |
| Strong Acid | 3 (Intermediate) | Aug. 25, 2024 |
| Weak Acid | 2 (Beginner) | Aug. 20, 2024 |
| Neutralization Reaction | 4 (Proficient) | Sep. 5, 2024 |
| Conjugate Acid-Base Pairs | 3 (Intermediate) | Aug. 28, 2024 |
| Buffer Solutions | 2 (Beginner) | Aug. 15, 2024 |
| Titration Curves | 3 (Intermediate) | Sep. 1, 2024 |
| Indicators | 4 (Proficient) | Sep. 3, 2024 |

TABLE 3
Learning Map Edges

| Concept 1 | Concept 2 | Weight | Explanation |
|---|---|---|---|
| Acid | Base | 0.9 | Acids and bases react together in neutralization |
| | | | reactions. |
| Acid | pH Scale | 0.8 | pH scale measures the acidity of a solution. |
| Base | pH Scale | 0.8 | pH scale also measures basicity (alkalinity). |
| Strong Acid | Acid | 0.7 | Strong acids completely dissociate in water. |
| Weak Acid | Acid | 0.7 | Weak acids partially dissociate in water. |
| Strong Acid | pH Scale | 0.6 | Strong acids significantly lower the pH due to |
| | | | full dissociation. |
| Weak Acid | pH Scale | 0.6 | Weak acids affect pH less because of partial |
| | | | dissociation. |
| Neutralization | Acid | 0.7 | Acids react with bases in neutralization |
| Reaction | | | reactions. |
| Neutralization | Base | 0.7 | Bases react with acids during neutralization. |
| Reaction | | | |
| Conjugate | Acid | 0.6 | Acids form conjugate bases after donating a |
| Acid-Base | | | proton. |
| Pairs | | | |
| Conjugate | Base | 0.6 | Bases form conjugate acids after accepting a |
| Acid-Base | | | proton. |
| Pairs | | | |
| Buffer | Weak Acid | 0.8 | Buffers consist of weak acids and their |
| Solutions | | | conjugate bases to resist pH changes. |
| Buffer | Conjugate Acid- | 0.9 | Buffer effectiveness depends on conjugate acid- |
| Solutions | Base Pairs | | base pairs. |
| Titration | Neutralization | 0.7 | Titration curves represent pH changes during |
| Curves | Reaction | | neutralization reactions. |
| Titration | pH Scale | 0.7 | pH scale is fundamental to interpreting titration |
| Curves | | | curves. |
| Indicators | pH Scale | 0.7 | Indicators change color based on pH values. |
| Indicators | Titration Curves | 0.6 | Indicators help determine equivalence points in |
| | | | titrations. |
| Buffer | pH Scale | 0.6 | Buffers maintain a stable pH, directly relating to |
| Solutions | | | the pH scale. |
| Conjugate | Buffer Solutions | 0.9 | Buffers are effective with equal amounts of |
| Acid-Base | | | conjugate pairs. |
| Pairs | | | |
| Strong Acid | Neutralization | 0.6 | Strong acids fully react with bases during |
| | Reaction | | neutralization. |

Further, the instructor's input, outlined in Table 4, provides lesson parameters, including the current topic (“Acids and Bases”), preferred teaching materials, learning concepts, and assessment methods.

TABLE 4
Instructor Input

| Field | Data Type | Description | Sample Data |
|---|---|---|---|
| Instruction Type | String | Category of the instruction | Lab Time |
| Description | String | Explanation of the instruction | Active labs 20% |
| Boundaries | String | Limitations or specifics | 2 hours per week |
| Syllabus | String | The course outline with | Chemical Bonding |
| | | topics covered | Acids and Bases |
| | | | (current topic) |
| | | | Stoichiometry |
| | | | Thermodynamics |
| | | | Chemical |
| | | | Equilibrium |
| | | | Critical Thinking |
| | | | Communication |
| | | | skills |
| Teaching material | String | The teaching materials that | Main textbook used |
| | | the instructor uses in class | in class |
| | | | Last year's exam |
| Learning Concepts | String | The subject matter to be | Understanding the |
| | | covered. These will be | logarithmic nature of the |
| | | reflected as a collection of | pH scale |
| | | nodes on the learning map. | |
| Learning Concepts | Dictionary | Importance of each concept | [ |
| Priority | | on a scale from 1-10 | {“pH Scale”, 8}, |
| | | | {“Acids”, 8}, |
| | | | ] |
| Assessment | Enum[ ] | How the learning objective | [Lab, Quiz] |
| Method | | will be assessed | |

As Tom begins his learning session, the system generates a tailored 3D virtual environment based on his learner profile and the current learning objectives provided by the instructor. The Personalization Classifier processes the input data to create an immersive and engaging learning experience aligned with Tom's interests and educational needs.

Turning again to FIG. 15, Tom enters the Thinking Activation stage within a Mars-themed environment 1502, selected to engage him based on his interests in space and gaming. The Adaptive Agent greets Tom and introduces the learning objectives in this context.
a) Environment Selection: The Mars setting provides a novel and intriguing backdrop, enhancing engagement.
b) Introduction of Learning Objectives: The AI tutor outlines the focus on acids and bases, relating them to the Martian environment.

The Pedagogy Classifier 111, utilizing the Learning Activity Library, has selected interactive activities relevant to acids and bases:
a) Interactive Quiz: Assessing prior knowledge on the pH scale.
b) Object Identification Activity: Finding and classifying substances in the environment as acids or bases.

The Environment State Processor 141/411 captures Tom's interactions, converting them into structured textual data. This data is processed by the Artificial Neural Network (ANN) (Adaptive Agent 131) to understand Tom's engagement and adapt the learning experience in real-time.

Tom progresses to the Knowledge Check stage 1503. The Learning Data Classifier assesses his baseline understanding of the pH scale through the interactive quiz.
a) Performance Analysis: Based on his responses, the system identifies areas of strength and concepts requiring reinforcement.
b) Learning Map Update: Tom's Learning Map is updated to reflect his current mastery levels.

During the Learning Activity stage 1504, Tom is tasked with identifying acidic substances in the Martian environment.
a) Challenge Presented: “Find an acidic food item.”
b) Data Collection: The system collects various quantitative metrics during this task, as outlined in Table 5:

TABLE 5
Quantitative Metrics Collected During the Task

| Field | Data Type | Description | Value |
|---|---|---|---|
| Time on Task | TimeSpan | Amount of time spent on a particular task | 3 minutes |
| Task Repeats | Integer | Number of times a task was repeated | 0 |
| Clicks per Task | Integer | Number of interactions within a task | 4 |
| Facial | Dictionary | Facial micro expressions are recorded and | { |
| Expressions | | processed by an ML algorithm to estimate | Reflecting: 3%, |
| | | the learner's emotions during each task. | Excited: 21%, |
| | | | Curious: 12%, |
| | | | Confused: 34%, |
| | | | Frustrated: 1% |

Dynamic Adaptation: The metrics indicate that Tom is spending more time than expected and shows signs of confusion (34%). Recognizing this, the Adaptive Agent dynamically modifies the learning environment:
a) Content Adjustment: Additional varieties of fruits are created within the environment.
b) Guidance Provided: The AI tutor explains why certain foods are acidic, providing contextual examples.
c) Reinforcement: Tom is asked to find more acidic food items to reinforce the learning.

Next, Tom reaches the Assessment Gate 1505. His performance is evaluated:
a) Successful Completion: After the adaptations, Tom answers all questions correctly.
b) Profile Update: The Learning Data Classifier updates his Learning Map and learner profile to reflect improved mastery.

Gamification and Motivation: To motivate further engagement, the system 100 can incorporate gamification elements aligned with Tom's gamer profile:
a) Reward System: Tom receives a badge for completing the learning module 1506.
b) Encouragement: The AI tutor encourages Tom to continue exploring additional challenges.

Continued Engagement: A week later, the system supports continuous learning:
a) Knowledge Reinforcement: Tom receives a notification on his phone with a popup quiz designed to reinforce his knowledge.
b) Adaptive Scheduling: The system determines optimal times for engagement based on Tom's interaction patterns and preferences.

Through the example embodiment described above with reference to FIGS. 13-15, the system 100 demonstrates several benefits and advantages:
a) Real-Time Adaptation: By converting 3D environment states into structured textual data, the system enables seamless, real-time adaptations with minimal latency and bandwidth usage. This allows for a highly responsive and personalized learning journey.
b) Artificial Neural Network Processing: The ANN processes the structured data to generate adaptation instructions, which the Adaptive Agent executes to modify the virtual environment dynamically.
c) Cross-Platform Compatibility: The system operates consistently across various devices, ensuring accessibility and convenience for the learner.
d) Learner-Centric Personalization: By integrating the learner's profile, interests, and performance data, the system delivers a customized learning experience that aligns with Tom's needs and preferences.
e) Efficient Data Handling: The use of structured textual data reduces bandwidth requirements and computational overhead, enabling real-time responsiveness even in complex virtual environments.
f) Emotional Intelligence Integration: The optional emotion-tracking enhances personalization by adapting to the learner's emotional state, although in this scenario, it is used with user consent and privacy safeguards.

This example embodiment demonstrates a practical application of the invention, highlighting the interactions between the system's components and their collective role in enhancing the educational experience. By providing a detailed walkthrough of Tom's learning journey, the embodiment illustrates how the adaptive learning system personalizes content, responds to learner needs in real-time, and utilizes advanced technologies to create an immersive and effective learning environment.

### Embodiment of Emotion-Tracking Integration

Emma, preparing for her calculus exam, uses the system's optional emotion-tracking feature. With her consent, the system analyzes her facial expressions and interaction patterns. When Emma shows signs of frustration after several incorrect attempts, the ANN processes this emotional data and instructs the Adaptive Agent (via the AI tutor) to provide supportive feedback: “I think this problem is challenging. Would you like to review some similar examples together?” The system then adjusts the difficulty level and pacing to help Emma overcome her frustration and improve her understanding.

### Embodiment in Language Learning

A language learning application leverages the system to create immersive conversational experiences. Learners engage in dialogues within 3D virtual environments simulating real-life contexts, such as restaurants or business meetings. The Environment State Processor captures spoken inputs and interactions, converting them into structured textual data including pronunciation, vocabulary, and grammar metrics. The ANN processes this data along with the learner's proficiency level to generate adaptive responses from virtual characters, adjusting conversation complexity and providing immediate feedback.

### Embodiment in Special Education

The system adapts to support learners with diverse needs in special education settings. For a learner with visual impairments, it may emphasize audio cues and haptic feedback in VR environments. For learners with attention deficit disorders, the system might break complex tasks into smaller, more manageable steps, adjusting the pacing based on real-time engagement metrics. The ANN continuously refines its approach based on each learner's unique response patterns, ensuring an optimized learning experience.

### Embodiment in Vocational Training

In a culinary arts program, the system creates a virtual kitchen environment. Learners practice cooking techniques, ingredient combinations, and time management. The Environment State Processor captures data on virtual ingredient selection, cooking methods, and timing. The ANN analyzes this data to provide real-time feedback on technique, flavor combinations, and efficiency. As learners progress, the system introduces more complex recipes and time-pressured scenarios, simulating real-world kitchen environments.

### Features of Example Embodiments

The system 100, as well as further embodiments described herein, may exhibit some or all of the features noted below:

### 1. Dynamic Generation of Personalized 3D Learning Environments

### Adaptive Environment Creation:

a) Learner-Centric Profiles: The system dynamically generates 3D learning environments tailored to individual learner profiles, encompassing diverse learning styles, preferences, and prior knowledge levels.
b) Instructor-Driven Inputs: Educators can input specific syllabi, learning objectives, and content requirements, ensuring that the virtual environment aligns seamlessly with curricular goals and pedagogical strategies.
c) Curriculum Alignment: The system integrates curriculum standards and educational goals, guaranteeing that each personalized environment adheres to established academic frameworks and benchmarks.

This multi-faceted approach ensures that each 3D learning environment is uniquely customized to both the learner and the educational objectives, enhancing engagement and educational efficacy in a manner not disclosed or suggested by prior art.

2. Conversion of 3D Environment States into Structured Textual Data

### Innovative Data Representation:

a) Comprehensive State Capture: The system meticulously captures the state of the 3D virtual environment, including precise object positions, properties, and detailed learner interactions.
b) Structured Textual Conversion: This captured data is transformed into structured textual representations (e.g., JSON, XML), facilitating efficient processing and interoperability with Artificial Neural Networks (ANNs).

By converting complex visual and interactive data into structured text, the system achieves a significant reduction in bandwidth consumption compared to traditional high-volume visual data transmission. This method enables real-time processing and seamless adaptation, making advanced adaptive learning accessible even in bandwidth-constrained environments.

### 3. Processing by Artificial Neural Networks (ANNs) for Real-Time Adaptation

### Advanced ANN Integration:

a) Structured Data Processing: Example embodiments leverage ANNs to interpret the structured textual data representing the 3D environment's state, enabling sophisticated analysis and decision-making.
b) Real-Time Instruction Generation: The ANN generates precise adaptation instructions, including executable function calls, which are used to modify the virtual environment instantaneously.

This direct utilization of ANNs to process structured textual data for real-time environment modifications provides a highly responsive and personalized learning experience, distinguishing it from prior systems that rely on less efficient data processing methods.

### 4. Real-Time Personalization and Adaptation of Learning Experiences

### Immediate Adaptive Responses:

a) Interactive Adaptation: The system continuously monitors learner interactions within the 3D space, utilizing real-time performance metrics and, optionally, emotional state data to inform adaptive changes.
b) Personalized Adjustments: Based on the collected data, the system dynamically adjusts content difficulty, presentation styles, and pacing to match the learner's evolving needs and engagement levels.

The ability to deliver instantaneous, personalized adjustments within a 3D environment based on comprehensive real-time data analysis is a pioneering feature not addressed or suggested by existing adaptive learning technologies.

### 5. Bandwidth and Computational Efficiency

### Optimized Resource Utilization:

a) Structured Data Transmission: Utilizing structured textual data instead of bulky visual streams drastically reduces bandwidth requirements, enhancing system performance and accessibility.
b) Client-side Processing: By executing the processing of 3D environment states directly on the client side, the system significantly reduces server-side computational demands, thereby enhancing scalability and achieving greater cost-effectiveness.

This dual approach of structured data transmission and client-side processing ensures that the system remains efficient and functional across devices with varying computational capabilities and in regions with limited internet connectivity, setting it apart from conventional adaptive learning systems.

### 6. Comprehensive Integration of Learner Profiles and Instructor Inputs

### Holistic Personalization Framework:

a) Detailed Learner Profiles: The system incorporates extensive learner profiles, including learning preferences, strengths, weaknesses, and historical performance data, to inform adaptive strategies.
b) Instructor-Defined Parameters: Educators can input lesson parameters, such as educational objectives, content restrictions, and pedagogical strategies, ensuring that the adaptive content aligns with instructional goals.
c) Curriculum Compliance: Integration with curriculum requirements and educational standards ensures that personalized learning paths adhere to necessary academic guidelines.

This comprehensive integration facilitates the creation of highly personalized and pedagogically sound learning experiences, enabling the system to cater to both individual learner needs and broader educational objectives seamlessly.

### 7. Cross-Platform Compatibility and Scalability

### Versatile Deployment:

a) Multi-Device Support: The system is engineered to operate seamlessly across a wide range of platforms, including desktops, mobile devices, virtual reality (VR) headsets, and augmented reality (AR) devices.
b) Scalable Architecture: Designed with scalability in mind, the architecture supports extensive user bases and diverse educational contexts without necessitating significant infrastructure investments.

The ability to maintain consistent functionality and performance across multiple platforms, coupled with a scalable design, ensures widespread applicability and ease of adoption in various educational and training environments, unlike prior systems with limited platform support.

### 8. Optional Emotion-Tracking Integration

### Enhanced Emotional Intelligence:

a) Non-Invasive Emotion Detection: The system can incorporate emotion-tracking capabilities to monitor the learner's emotional state through non-invasive indicators such as facial expressions and interaction patterns.
b) Adaptive Emotional Responses: Based on the detected emotional data, the ANN adjusts the learning environment to maintain or enhance learner engagement, such as modifying content difficulty or providing supportive feedback.

The integration of emotional state data with real-time environment adaptation via ANNs processing structured textual data provides a deeper level of personalization and learner support, a feature not present in existing adaptive learning technologies.

### 9. Direct Generation of Executable Function Calls by ANNs

### Streamlined Adaptation Mechanism:

a) Executable Instructions: The ANN directly generates executable function calls based on processed structured textual data, enabling immediate modifications to the 3D environment.
b) Elimination of Intermediate Layers: This direct approach removes the need for intermediary translation layers, enhancing the system's efficiency and responsiveness.

By enabling the ANN to generate and execute function calls without intermediary steps, the system ensures rapid and accurate environment adaptations, significantly improving the learning experience's fluidity and interactivity compared to traditional methods.

### 10. Adaptive Content Generation

### Dynamic Content Customization:

a) Interactive 3D Objects and Scenarios: The system can dynamically create and modify 3D objects and scenarios to align with the learner's current activities and learning objectives.
b) Personalized Narratives and Explanations: The ANN generates tailored narratives and explanations that resonate with the learner's interests and comprehension levels.
c) Adaptive Assessment Questions: Assessment tools are dynamically adjusted to reflect the learner's progress and areas needing reinforcement, ensuring that evaluations remain relevant and effective.

The capability to continuously generate and modify learning content in real-time ensures that the educational material remains engaging, relevant, and precisely tailored to the learner's needs, providing a level of adaptability and personalization beyond what is available in prior adaptive learning systems.

### Challenges and Solutions

Providing an adaptive learning system as described herein can present certain challenges. Those challenges, and their solutions, are discussed below. Example embodiments may incorporate some or all of the solutions provided below.

### 1. Reliance on ANN Accuracy and Consistency

### Challenge:

a) Model Errors and Inconsistencies: ANNs may occasionally produce incorrect or inappropriate outputs, including factual inaccuracies, irrelevant content, or unintended biases.
b) Contextual Misinterpretation: The ANN might misinterpret structured textual data or learner inputs, leading to inappropriate adaptations or feedback.

### Solutions:

a) Fine-Tuning and Continuous Training:
   i. Regularly fine-tune the ANNs using domain-specific datasets and real-world interaction logs to improve accuracy and relevance.
   ii. Incorporate feedback mechanisms where incorrect outputs are identified and used to retrain the model.
b) Implementing Verification Layers:
   i. Introduce an intermediary verification process where outputs from the ANN are checked against predefined rules or knowledge bases before being executed.
   ii. Use additional AI models or algorithms to validate the ANN's responses for correctness and appropriateness.
c) Bias Mitigation Strategies:
   i. Employ techniques to identify and mitigate biases within the ANN, such as debiasing algorithms and diverse training data.
   ii. Regularly audit the model outputs to ensure fairness and inclusivity.
d) Fallback Mechanisms:
   i. In cases where the ANN's confidence in its output is low, default to pre-validated educational content or simpler adaptive responses.
   ii. Allow instructors to review and approve certain types of content or adaptations before deployment.
e) Retrieval-Augmented Generation (RAG):
   i. Implement RAG techniques to enhance the ANN's accuracy and contextual understanding.
   ii. RAG allows the model to access and incorporate relevant information from a curated knowledge base during generation, reducing reliance on potentially outdated or inaccurate information in the model's pre-trained weights.
   iii. This approach can significantly improve the factual accuracy and relevance of the ANN's outputs, particularly in domains with rapidly evolving knowledge or where precise, up-to-date information is crucial.

### 2. Privacy and Data Security Concerns

### Challenge:

a) Sensitive Data Handling: Processing learner profiles, performance metrics, and emotional state data raises concerns about privacy and data protection.
b) Regulatory Compliance: Compliance with data protection regulations like GDPR and CCPA is mandatory, and any lapses can lead to legal consequences.

### Solutions:

a) Strict Data Encryption and Anonymization:
   i. Implement robust encryption protocols for data both in transit and at rest (e.g., TLS for transmission, AES-256 for storage).
   ii. Anonymize personal data where possible, ensuring that individual learners cannot be identified from the stored data.
b) User Consent and Control:
   i. Obtain explicit consent from users for data collection, especially for sensitive data like emotional states.
   ii. Provide users with control over their data, including options to view, modify, or delete their personal information.
c) Compliance Framework:
   i. Establish a compliance framework adhering to relevant regulations, with regular audits and assessments.
   ii. Maintain transparent privacy policies and clear communication with users regarding data handling practices.
d) Client-side Processing:
   i. Where feasible, perform data processing on the client side to minimize data transmission.
   ii. Use federated learning approaches to update models without transferring raw data to central servers.

### 3. Computational Resource Requirements

Challenge: High Computational Demand: ANNs, especially large models, require significant computational resources, which may limit real-time processing capabilities and increase costs.

### Solutions:

a) Model Optimization:
   i. Utilize techniques such as model pruning, quantization, and knowledge distillation to reduce model size and improve efficiency.
   ii. Deploy smaller, optimized models suitable for on-device processing for certain tasks.
b) Edge Computing and Caching:
   i. Leverage edge computing to process data closer to the learner's device, reducing latency and server load.
   ii. Implement intelligent caching mechanisms to store frequently accessed data and responses.
c) Scalable Infrastructure:
   i. Use cloud platforms with scalable resources to handle variable computational loads effectively.
   ii. Employ load balancing and resource allocation strategies to optimize performance during peak usage.
d) Asynchronous Processing: Design the system to handle non-critical tasks asynchronously, ensuring that real-time interactions remain smooth.
   4. Integration Challenges with Existing Systems

Challenge: Compatibility Issues: Integrating the adaptive learning system with existing educational platforms, Learning Management Systems (LMS), or corporate training systems may present technical challenges.

### Solutions:

a) API and Standards Compliance:
   i. Develop standardized APIs and adhere to industry protocols (e.g., LTI, SCORM, xAPI) to facilitate seamless integration.
   ii. Provide comprehensive documentation and support for integration processes.
b) Modular Architecture:
   i. Design the system with modular components that can operate independently or integrate with various systems.
   ii. Allow for customization and configuration to meet specific institutional requirements.
c) Pilot Programs and Phased Deployment:
   i. Implement pilot programs to test integration in a controlled environment, identify issues, and refine the process.
   ii. Use phased deployment strategies to gradually integrate the system, reducing disruption to existing operations.

### 5. User Acceptance and Training

Challenge: Resistance to New Technology: Educators and learners may be hesitant to adopt a new system due to unfamiliarity or skepticism about its effectiveness.

### Solutions:

a) User-Friendly Design:
   i. Ensure that the user interface is intuitive and accessible, minimizing the learning curve for new users.
   ii. Incorporate user feedback into the design process to address usability concerns.
b) Training and Support:
   i. Provide comprehensive training programs for educators and administrators to familiarize them with the system's features and benefits.
   ii. Offer ongoing technical support and resources to assist users in overcoming challenges.
c) Demonstrating Effectiveness:
   i. Share case studies, testimonials, and evidence of improved learning outcomes to build confidence in the system.
   ii. Encourage early adopters to champion the technology within their institutions.

### 6. Potential Biases in AI and Ethical Considerations

Challenge: Bias in AI Outputs: ANNs trained on large datasets may inadvertently reinforce societal biases, leading to unfair or discriminatory outputs.

### Solutions:

a) Diverse and Inclusive Training Data:
   i. Use training datasets that are diverse and representative to minimize inherent biases.
   ii. Continuously update the training data to reflect current societal values and reduce outdated stereotypes.
b) Ethical Guidelines and Oversight:
   i. Establish ethical guidelines for AI use within the system, with oversight mechanisms to monitor compliance.
   ii. Empower a committee or task force to review and address ethical concerns related to AI outputs.
c) Transparency and Explainability:
   i. Develop methods to increase the transparency of AI decision-making processes.
   ii. Provide explanations for certain adaptive decisions or outputs to educators and learners when appropriate.

### 7. Technical Constraints and Reliability

### Challenges:

a) Dependence on Device Capabilities: The system's performance may vary based on the hardware and network capabilities of the learner's device.
b) System Downtime and Failures: Technical issues or server downtime could disrupt the learning experience.

### Solutions:

a) Optimized Performance:
   i. Implement adaptive quality adjustments based on device performance, ensuring core functionalities remain accessible.
   ii. Use lightweight client applications that can operate efficiently on lower-spec devices.
b) Redundancy and Failover Mechanisms:
   i. Configure the infrastructure with redundancy to handle server failures without service interruption.
   ii. Implement failover strategies to switch to backup systems seamlessly in case of technical issues.
c) Offline Functionality:
   i. Develop offline modes where certain learning activities can continue without network connectivity.
   ii. Synchronize data and updates once the connection is restored.

### 8. Regulatory Compliance and Content Localization

### Challenges:

a) Variations in Educational Standards: Different regions may have specific educational standards and regulations that the system needs to comply with.
b) Language and Cultural Localization: Adapting content to different languages and cultural contexts is essential for global deployment.

### Solutions:

a) Compliance Configuration:
   i. Design the system to be configurable according to regional educational standards and legal requirements.
   ii. Work with local educational authorities to ensure alignment with curricular frameworks.
b) Multilingual Support:
   i. Employ ANNs capable of processing and generating content in multiple languages.
   ii. Include localization teams to adapt content culturally and contextually for different regions.
c) Content Moderation: Implement content moderation tools to review and approve content, ensuring suitability for the target audience.

### 9. Ethical Use of Emotion-Tracking Data

### Challenges:

a) Privacy Concerns: Collecting emotional state data may raise privacy issues and ethical questions regarding surveillance and data use.
b) Potential Misinterpretation: Emotion-detection algorithms may inaccurately interpret emotional states, leading to inappropriate adaptations.

### Solutions:

a) Informed Consent:
   i. Require explicit, informed consent from users before activating emotion-tracking features.
   ii. Provide clear information about how emotional data will be used and protected.
b) Opt-Out Options: Allow users to disable emotion-tracking at any time without affecting their access to the rest of the system's features.
c) Accuracy and Validation:
   i. Use validated and reliable emotion-detection algorithms, with regular assessments of accuracy.
   ii. Cross-reference emotional data with behavioral indicators to improve interpretation.
d) Ethical Guidelines: Establish strict ethical guidelines for the use of emotional data, including limitations on data access and usage.

### 10. Continuous Improvement and Adaptability

Challenge: Technology Evolution: Rapid advancements in AI and educational technology may render certain aspects of the system outdated.

### Solutions:

a) Modular and Flexible Design:
   i. Architect the system to allow for easy updates and integration of new technologies.
   ii. Use modular components that can be independently upgraded or replaced.
b) Continuous Research and Development:
   i. Invest in ongoing R&D to stay abreast of technological advancements and incorporate innovations.
   ii. Collaborate with academic and industry partners to enhance system capabilities.
c) Feedback Loops:
   i. Establish mechanisms for collecting user feedback to identify areas for improvement.
   ii. Use data analytics to monitor system performance and inform updates.

### Further Applications of Example Embodiments

Embodiments of the adaptive learning system described herein exhibit extensive industrial applicability across a multitude of sectors that require efficient, personalized, and scalable training and educational solutions. Its innovative approach of converting three-dimensional (3D) environment states into structured textual data for processing by Artificial Neural Networks (ANNs) enables real-time adaptation and personalization in immersive learning environments. This method addresses critical challenges such as high bandwidth consumption, latency, and computational costs, making advanced adaptive learning technologies accessible and practical for widespread industrial use.

### 1. Education and Academic Institutions

### Primary and Secondary Education:

a) Personalized Learning Paths:
   i. The system can be implemented in schools to provide tailored learning experiences that adapt to individual student needs, learning styles, and pace.
   ii. Supports differentiated instruction, allowing educators to address diverse student abilities within the same classroom.
b) Resource Optimization:
   i. Reduces the need for extensive physical materials and laboratory equipment by providing virtual simulations and experiments.
   ii. Offers cost-effective solutions for schools with limited budgets, especially in under-resourced areas with bandwidth constraints.

### Higher Education:

a) Enhanced Engagement: Universities can utilize the system to create immersive, interactive courses that increase student engagement and comprehension in complex subjects.
b) Virtual Laboratories: Allows for the simulation of advanced experiments and scenarios that may be too dangerous, expensive, or impractical to perform in real life.
c) Remote Learning Support: Provides robust adaptive learning tools suitable for online education platforms, supporting distance learning initiatives.

### 2. Corporate Training and Professional Development

### Employee Onboarding and Training:

a) Customized Training Programs: Corporations can deploy the system to create personalized training modules that adapt to each employee's existing knowledge and skill gaps.
b) Scalable Solutions: Supports large-scale training initiatives without proportional increases in training costs or logistical challenges.

### Continued Professional Development:

a) Up-to-Date Content: Enables organizations to keep training materials current and relevant by dynamically generating content that reflects the latest industry practices and regulations.
b) Performance Tracking: Provides detailed analytics on employee progress, enabling targeted interventions and support.

Simulation of Real-World Scenarios: A risk-free environment allows employees to practice and develop skills in a simulated environment, reducing the risk of errors in critical real-world applications.

### 3. Healthcare and Medical Training

### Medical Education:

a) Anatomical and Procedural Simulations: Medical schools and training programs can use the system to provide detailed, interactive simulations of human anatomy and surgical procedures.
b) Adaptive Learning for Complex Concepts: Tailors content to individual learners, ensuring that difficult concepts are understood before progressing.

Continuing Medical Education: Embodiments can teach the latest medical practices to keep healthcare professionals updated with the most recent medical advancements and treatment protocols through dynamic content generation.

Patient Education: Clinics and hospitals can use the system to educate patients about their conditions and treatments in an interactive manner, improving patient outcomes.

### 4. Engineering and Technical Fields

### Engineering Education and Training:

a) Simulation of Complex Systems: Engineering programs can simulate mechanical, electrical, and civil engineering scenarios, allowing students to experiment and learn without physical prototypes.
b) Real-Time Problem Solving: Adapts challenges based on the learner's performance, enhancing critical thinking and practical application skills.

Technical Skills Development: Equipment Operation Training: Industries such as manufacturing and aerospace can train personnel on the operation and maintenance of complex machinery through virtual simulations.

### 5. Vocational and Skill-Based Training

### Trades and Apprenticeships:

a) Hands-On Practice: Provides virtual environments where learners can practice trades such as welding, plumbing, and electrical work safely and without resource constraints.
b) Adaptive Feedback: Offers immediate, personalized feedback to improve skill acquisition and proficiency.

Certification and Compliance Training: Standardized Learning Outcomes: Ensures consistent training quality across different locations and trainers, important for certifications that require adherence to specific standards.

### 6. Military and Defense Training

### Simulation of Tactical Scenarios:

a) Risk-Free Environment: Allows military personnel to engage in tactical training exercises in a virtual setting, reducing the risks associated with live training.
b) Adaptive Difficulty: Adjusts the complexity of scenarios based on the trainee's performance, enhancing preparedness.

### Equipment and Protocol Training:

a) Familiarization with Advanced Systems: Provides training on the use and maintenance of sophisticated defense equipment.
b) Procedural Compliance: Reinforces adherence to protocols through adaptive learning experiences.

### 7. Aerospace and Aviation

### Pilot and Crew Training:

a) Flight Simulations: Offers highly detailed and adaptive flight simulations for pilot training, including emergency scenarios and diverse weather conditions.
b) Maintenance Training: Provides virtual training for aircraft maintenance and safety inspections.

Space Exploration Training: Mission Simulations: Assists in preparing astronauts for space missions by simulating zero-gravity environments and spacewalks.

### 8. Environmental Science and Sustainability

Conservation Education: Interactive Ecosystem Simulations: Educates learners on environmental impacts through simulations of ecosystems and human interactions.

Sustainability Training: Corporate Compliance: Trains employees on sustainable practices and regulatory compliance in industries such as energy, agriculture, and manufacturing.

### 9. Entertainment and Media Industry

Game Development and Design Education: Interactive Learning: Teaches game design and programming through immersive learning environments that adapt to the learner's skill level.

Virtual Production Training: Film and Animation: Provides training on virtual production techniques used in modern filmmaking and animation, including real-time rendering and motion capture.

### 10. Language Learning and Cultural Education

Immersive Language Training: Real-World Simulations: Offers learners the ability to practice languages in simulated environments reflective of native-speaking contexts.

Cultural Competency: Interactive Cultural Scenarios: Educates users on cultural norms and practices through adaptive simulations, beneficial for global business and diplomacy.

### 11. Accessibility and Special Education

### Customized Learning for Diverse Needs:

a) Adaptive Content Delivery:
b) Supports learners with disabilities by adapting content presentation to accommodate visual, auditory, or cognitive impairments.

### Therapeutic Applications:

a) Rehabilitation Training:
b) Assists in cognitive and motor skill rehabilitation through tailored exercises and simulations.

### 12. Research and Development

Educational Technology Research: Data Analytics: Provides valuable data on learning behaviors and effectiveness of adaptive learning strategies, contributing to educational research.

AI and ML Development: Advancement of Algorithms: The system's innovative approach contributes to advancements in artificial intelligence and machine learning, particularly in natural language processing and adaptive algorithms.

### 13. Global Reach and Remote Accessibility

### Education in Remote Areas:

a) Overcoming Infrastructure Limitations: The system's low bandwidth requirements make it suitable for deployment in areas with limited internet infrastructure.
b) Supporting Lifelong Learning: Enables access to quality education and training resources globally, promoting equality and inclusion.

### 14. Emergency Services and Disaster Response Training

Simulation of Crisis Scenarios: Adaptive Emergency Training: Provides first responders with realistic training simulations that adapt to their actions, improving readiness for actual emergencies.

Public Safety Education: Community Training Programs: Educates the public on disaster preparedness through interactive and personalized learning experiences.

### 15. Potential for Innovation and New Industry Applications

### Entrepreneurship and Innovation:

a) Prototype Development: Facilitates rapid prototyping and testing of new ideas in a virtual environment, lowering barriers to innovation.
b) Customized Corporate Training: Businesses can develop proprietary training modules tailored to their specific processes and products.

As described above, the industrial applicability of the adaptive learning system in example embodiments is vast and multifaceted. Its innovative method of converting 3D environment states into structured textual data for ANN processing makes it a versatile tool capable of transforming training and education across numerous industries. By addressing critical challenges such as bandwidth limitations, latency, and high operational costs, the system provides a practical and efficient solution for delivering personalized, adaptive learning experiences at scale.

Industries worldwide can leverage this technology to enhance workforce skills, improve educational outcomes, support remote and underserved populations, and foster innovation. The system's adaptability ensures that it can meet the unique needs of different sectors, making it a valuable asset in the ongoing advancement of education and professional development in the digital age.

Through its broad applicability, example embodiments hold the potential to revolutionize how knowledge and skills are acquired, contributing significantly to economic growth, societal advancement, and the democratization of education and training resources globally.

### Glossary of Terms

Adaptive Agent: An artificial intelligence component that serves as the primary interface between the learner and the adaptive learning system. Embodied as a virtual (AI) tutor, the Adaptive Agent is powered by an Artificial Neural Network (ANN) and, based on learner interactions and performance, executes real-time modifications to the three-dimensional (3D) virtual environment. The AI tutor provides personalized guidance, feedback, and support within the learning environment, enhancing learner engagement and facilitating adaptive learning.

Adaptive Learning System: An AI-driven educational platform that personalizes learning experiences by dynamically adjusting content, difficulty levels, and presentation styles based on individual learner profiles, real-time performance data, and interactions within the 3D environment. The system integrates advanced artificial intelligence with immersive technologies to deliver tailored educational experiences that adapt to each learner's needs.

Adaptive 3D Learning Environment: An immersive, interactive virtual space where learning experiences unfold. Capable of real-time modifications, this environment responds to adaptive instructions from the Adaptive Agent to enhance personalization and engagement. Learners interact with virtual objects and scenarios that are dynamically adjusted to align with their learning objectives and performance.

Augmented Reality (AR): A technology that overlays digital information onto the real world, augmenting the user's perception and interaction with their environment. In the context of example embodiments, the adaptive learning system can be deployed on AR devices, integrating virtual learning elements with the physical environment to create blended learning experiences.

Bandwidth Optimization: The process of reducing data transmission requirements to improve efficiency and performance, particularly in network communications. In example embodiments, bandwidth optimization is achieved by converting 3D environment states into structured textual data, significantly reducing the amount of data that needs to be transmitted compared to visual data streams. This optimization enhances accessibility and real-time responsiveness, especially in low-bandwidth conditions.

Function Calls: Executable instructions generated by the Artificial Neural Network (ANN) in response to processing structured textual data representing the 3D environment and learner interactions. Function calls are used by the Adaptive Agent to modify the virtual environment in real-time, creating personalized and adaptive learning experiences by adding, updating, or removing virtual objects and scenarios.

Interactive Objects: Virtual items within the 3D learning environment that learners can interact with. These objects have properties and states that can change in response to learner actions or adaptive instructions from the system. The properties and interactions of interactive objects are captured and converted into structured textual data for processing by the ANN.

Artificial Neural Network (ANN): A computational model inspired by the human brain's neural structure. ANNs comprise interconnected nodes organized in layers, designed to recognize patterns and solve complex problems by learning from examples. In our adaptive learning system, ANNs are crucial for processing learner data and enabling personalized content adaptation.

Latency: The delay between a user's action and the system's response. In the context of example embodiments, reducing latency is critical for real-time adaptation and a seamless user experience. By optimizing data processing and transmission through the use of structured textual data, the system minimizes latency, enhancing interactivity and learner engagement.

Learner Profile: A comprehensive dataset containing information about a learner's preferences, strengths, weaknesses, learning style, and performance history. The learner profile is continually updated based on real-time performance metrics and interactions. This profile informs the adaptive mechanisms of the system, allowing for personalized adjustments to the learning content and environment that cater to the individual learner's needs.

Learning Activity Templates: Pre-designed pedagogical frameworks that serve as templates for creating dynamic learning experiences. These templates define the structure of learning activities, which are then populated with personalized content generated by the ANN to align with the learner's profile and learning objectives. This approach combines educational best practices with the flexibility of AI-driven content generation.

Learning Objectives: Specific goals or outcomes that the learning experience aims to achieve. Learning objectives are tailored to each learner based on their profile, curriculum requirements, and prior performance metrics. The system uses these objectives to guide the adaptation of content and activities within the 3D environment, ensuring that learning experiences are aligned with desired educational outcomes.

Environment State Processor: A component of the system that operates on the client-side to capture the real-time state of the 3D virtual environment, including object positions, properties, and learner interactions. It converts this data into structured textual descriptions suitable for processing by the ANN. By performing this processing on the client-side, the system reduces the need for transmitting large volumes of data, optimizing bandwidth usage and latency.

Real-Time Adaptation: The immediate modification of the learning environment and content in response to the learner's actions, performance, and needs. Real-time adaptation is enabled by the system's ability to process data and execute changes instantaneously, providing a seamless and personalized learning experience that dynamically adjusts to optimize engagement and effectiveness.

Structured Textual Data: Formatted textual representations of complex data, such as the state of the 3D virtual environment and learner interactions. This data is structured in a way that allows the ANN to effectively process and understand the information, enabling it to generate appropriate adaptive responses. The use of structured textual data significantly reduces bandwidth requirements compared to transmitting visual data.

Virtual Reality (VR): A technology that immerses users in a simulated environment, typically through the use of VR headsets and specialized controllers. In the context of example embodiments, VR is one of the platforms through which the adaptive learning system can be accessed, providing highly immersive and interactive educational experiences that enhance learner engagement and understanding.

Emotion-Tracking Module (Optional Enhancement): An optional component of the system that detects and interprets the learner's emotional state through non-invasive methods, such as facial expression analysis, voice tone recognition, or interaction patterns. The emotional data is used to further personalize the learning experience by adjusting content difficulty, presentation styles, or providing supportive feedback to maintain optimal engagement and learning effectiveness. The use of emotion tracking is subject to user consent and includes robust privacy protections.

Performance Metrics: Data points that indicate the learner's behavior and success in learning tasks, such as success rates, time taken to complete tasks, number of attempts, and accuracy of responses. Performance metrics are used to update the learner profile and inform adaptive responses from the system, ensuring that the learning experience remains aligned with the learner's progress and needs.

Scalability: The ability of the system to maintain performance levels and functionality when accommodating a growing number of users or increased demand. The efficient data handling and bandwidth optimization in example embodiments enhance scalability, allowing the adaptive learning system to support widespread adoption across various educational institutions and organizations without significant degradation in performance.

Structured Textual Data: Data that is organized in a specific format (e.g., JSON, XML) that allows for easy parsing and processing by software programs, in this case, enabling an ANN to interpret 3D environment states without visual data.

Personalization Mechanisms: The methods and processes by which the system tailors the learning experience to individual learners. This includes dynamic content generation, difficulty adjustment, adaptation to learning styles, and real-time environment modification based on learner interactions, performance metrics, and emotional state (if available). Personalization mechanisms are central to the system's ability to deliver effective and engaging adaptive learning experiences.

Cross-Platform Compatibility: The system's ability to function consistently across various devices and platforms, including desktop computers, mobile devices, VR headsets, and AR devices. Cross-platform compatibility ensures that learners can access the adaptive learning system using their preferred devices, and that the system maintains functionality and performance regardless of hardware differences.

While example embodiments have been particularly shown and described, it will be understood by those skilled in the art that various changes in form and details may be made therein without departing from the scope of the embodiments encompassed by the appended claims.

What is claimed is:

1. A computer-implemented method of generating a simulated environment, comprising:
obtaining prior performance metrics indicating behavior of a student in performing a prior learning task;
updating a student profile based on the prior performance metrics;
obtaining lesson parameters indicating content to be included in an interactive lesson;
generating rules for the interactive lesson based on the student profile and the lesson parameters;
applying the rules to a classifier trained via a reference data set representing prior performance of a student population;
generating, via the classifier, instructions for generating a simulated environment encompassing the interactive lesson; and
generating a representation of the simulated environment based on the instructions.

2. The method of claim 1, wherein the prior performance metrics include at least one of success rate, time taken to complete the prior learning task, and number of attempts at completing the prior learning task.

3. The method of claim 1, wherein updating the student profile include determining, based on the prior performance metrics, the student's aptitude for at least one of a plurality of distinct learning abilities.

4. The method of claim 1, wherein the lesson parameters include representations of at least one of 1) required subject matter, 2) restricted subject matter, 3) proportion of passive lesson time versus interactive lesson time, and 4) proportion of collaborative time versus non-collaborative time.

5. The method of claim 1, wherein the lesson parameters are based on a selection by an educator.

6. The method of claim 1, wherein the rules represent at least a subset of the lesson parameters and the student profile.

7. The method of claim 1, wherein the instructions include a table storing a set of parameters for generating the simulated environment encompassing the interactive lesson.

8. The method of claim 1, wherein the classifier is artificial neural network (ANN) operating a large language model (LLM).

9. The method of claim 1, further comprising configuring a student device to operate the simulated environment, the student device being at least one of a virtual reality (VR) headset, and augmented reality (AR) headset, and a smartphone.

10. The method of claim 1, further comprising:
obtaining performance metrics indicating behavior of the student associated with the simulated environment; and
generating subsequent rules for a subsequent interactive lesson based on the performance metrics.

11. The method of claim 5, further comprising:
applying the subsequent rules to the classifier;
generating, via the classifier, subsequent instructions for generating a subsequent simulated environment encompassing the subsequent interactive lesson; and
generating a representation of the subsequent simulated environment based on the subsequent instructions.

12. The method of claim 1, wherein the simulated environment is a simulated 3D environment encompassing interactive simulated objects within the 3D environment.

13. The method of claim 1, wherein the reference data set is a first reference data set, and wherein the classifier is trained via a second reference data set including parameters of reference simulated environments encompassing reference interactive lessons.

14. The method of claim 1, wherein the rules for the interactive lesson include a pedagogy mode defining at least one of 1) a sequence of content presentation and 2) a mode of content presentation.

15. The method of claim 1, further comprising:
determining an emotional state of the student during performance of the prior learning task based on the prior performance metrics; and
generating rules for the interactive lesson based on the emotional state.

16. The method of claim 1, wherein generating the rules for the interactive lesson includes generating a text-based representation of a simulated 3D environment, the rules for the interactive lesson including the text-based representation.

17. A computer-implemented method adapting a three-dimensional (3D) virtual learning environment, comprising:
capturing a current state of the 3D virtual learning environment, the state including data representing objects within the environment and the learner's interactions with the objects;
generating, from the captured state, structured textual data representing the objects and the interactions within the 3D virtual environment;
processing, by an artificial neural network (ANN), the structured textual data to generate adaptation instructions, wherein the adaptation instructions include at least one of function calls and commands for modifying the 3D virtual environment; and
modifying the 3D virtual environment based on the adaptation instructions.

18. The method of claim 17, wherein capturing the current state includes detecting positions, properties, and relationships of interactive objects within the 3D virtual environment.

19. The method of claim 17, wherein the structured textual data includes descriptions of the learner's interactions, including movements, object manipulations, and inputs.

20. The method of claim 17, further comprising processing, via the ANN, the structured textual data in conjunction with a learner profile that includes the learner's preferences, performance metrics, and learning objectives.

21. The method of claim 20, further comprising updating the learner profile based on the learner's interactions and performance within the 3D virtual environment.

22. The method of claim 17, further comprising executing, via an adaptive agent, the adaptation instructions generated by the ANN to modify the 3D virtual environment.

23. The method of claim 22, further comprising providing, via the adaptive agent, at least one of real-time feedback, guidance, and instructional content to the learner within the 3D virtual environment.

24. The method of claim 17, wherein converting the captured state into structured textual data reduces data transmission requirements compared to transmitting visual data, thereby optimizing bandwidth usage.

25. The method of claim 17, wherein the real-time modification of the 3D virtual environment includes dynamically creating, altering, or removing virtual objects or scenarios based on the adaptation instructions.

26. The method of claim 17, further comprising generating, via the ANN, adaptation instructions that adjust at least one of the difficulty level, presentation style, and pacing of the learning content based on the learner's interactions.

27. The method of claim 17, further comprising transmitting the structured textual data to a remote server for processing by the ANN, wherein the ANN is hosted on the remote server.

28. The method of claim 17, wherein the 3D virtual learning environment is accessed via at least one of a desktop computer, a mobile device, a virtual reality (VR) headset, and an augmented reality (AR) device.

29. The method of claim 17, wherein the structured textual data includes dynamic attributes of objects, including state changes, temperature, or other properties relevant to the learning experience.

30. The method of claim 17, further comprising generating the adaptation instructions based on the structured textual data and lesson parameters provided by an educator.

31. The method of claim 30, wherein the lesson parameters include educational objectives, content restrictions, or preferred pedagogical strategies.

32. The method of claim 17, wherein the adaptive learning experience includes personalized narratives or storylines generated by the ANN to enhance learner engagement.

33. The method of claim 17, further comprising detecting, via the ANN, an emotional state of the learner based on at least one of the structured textual data and emotion-tracking data.

34. The method of claim 33, wherein the adaptation instructions indicate modifications to the learning content or environment to maintain or enhance the learner's engagement based on the detected emotional state.

35. The method of claim 17, wherein the structured textual data is formatted in at least one of a plaintext, JSON, or XML format.

36. The method of claim 17, wherein the adaptation instructions generated by the ANN include instructions for generating or selecting pre-designed pedagogical frameworks or learning activity templates.
